(19) United States
(12) Patent Application Publication
(10) Pub. No.: US 2015/0100318 A1
(43) Pub. Date: Apr. 9, 2015

(54) SYSTEMS AND METHODS FOR MITIGATING SPEECH SIGNAL QUALITY DEGRADATION

(71) Applicant: QUALCOMM Incorporated, San Diego, CA (US)

(72) Inventors: Venkatraman Rajagopalan, San Diego, CA (US); Venkatesh Krishnan, San Diego, CA (US); Alok K. Gupta, San Diego, CA (US)

(73) Assignee: QUALCOMM Incorporated, San Diego, CA (US)

(21) Appl. No.: 14/046,806

(22) Filed: Oct. 4, 2013

(51) Int. Cl. G10L 19/16; G10L 21/02; G10L 13/00

(52) U.S. Cl. CPC G10L 19/167; G10L 13/00; G10L 21/02
USPC 704/264; 704/258

(57) ABSTRACT

A method for decoding a speech signal is described. The method includes obtaining a packet. The method also includes obtaining a previous lag value. The method further includes limiting the previous lag value if the previous lag value is greater than a maximum lag threshold. The method additionally includes disallowing an adjustment to a number of synthesized peaks if a combination of the number of synthesized peaks and an estimated number of peaks is not valid.

### TECHNICAL FIELD

The present disclosure relates generally to signal processing. More specifically, the present disclosure relates to mitigating speech signal quality degradation.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform functions faster, more efficiently or with higher quality are often sought after.

Some electronic devices (e.g., cellular phones, smart phones, computers, etc.) use audio or speech signals. These electronic devices may encode speech signals for storage or transmission. For example, a cellular phone captures a user's voice or speech using a microphone. For instance, the cellular phone converts an acoustic signal into an electronic signal using the microphone. This electronic signal may then be formatted for transmission to another device (e.g., cellular phone, smart phone, computer, etc.) or for storage.

Transmitting or sending an uncompressed speech signal may be costly in terms of bandwidth and/or storage resources, for example. Some schemes exist that attempt to represent a speech signal more efficiently (e.g., using less data). However, a speech signal may become corrupted, resulting in degraded performance. As can be understood from the foregoing discussion, systems and methods that mitigate speech signal quality degradation may be beneficial.

### SUMMARY

A method for decoding a speech signal is described. The method includes obtaining a packet. The method also includes obtaining a previous lag value. The method further includes limiting the previous lag value if the previous lag value is greater than a maximum lag threshold. The method additionally includes disallowing an adjustment to a number of synthesized peaks if a combination of the number of synthesized peaks and an estimated number of peaks is not valid.

The packet may be a packet with errors or the packet may include an erased frame. The method may be performed by a service option 77 enhanced variable rate codec vocoder.

The method may also include disallowing the adjustment to the number of synthesized peaks if an adjusted number of synthesized peaks is not within a maximum peak number threshold. The estimated number of peaks may be based on a current frame size and a current lag value.

The method may also include obtaining a current lag value. The method may further include declaring the packet as a bad packet if the current lag value exceeds a transient mode lag threshold.

The method may also include obtaining reserved bits from the packet. The method may further include declaring the packet as a bad packet if at least one reserved bit is a non-zero bit.

The method may include limiting the previous lag value if the previous lag value is less than a minimum lag threshold. The method may include limiting a prototype pulse length to a maximum length. The method may include limiting a difference in samples between two pulses in an excitation of a previous frame to a maximum difference threshold.

An electronic device for decoding a speech signal is also described. The electronic device includes receiver circuitry configured to obtain a packet. The electronic device also includes decoder circuitry configured to obtain a previous lag value, to limit the previous lag value if the previous lag value is greater than a maximum lag threshold, and to disallow an adjustment to a number of synthesized peaks if a combination of the number of synthesized peaks and an estimated number of peaks is not valid.

A computer-program product for decoding a speech signal is also described. The computer-program product includes a non-transitory tangible computer-readable medium having instructions thereon. The instructions include code for causing an electronic device to obtain a packet. The instructions also include code for causing the electronic device to obtain a previous lag value. The instructions further include code for causing the electronic device to limit the previous lag value if the previous lag value is greater than a maximum lag threshold. The instructions additionally include code for causing the electronic device to disallow an adjustment to a number of synthesized peaks if a combination of the number of synthesized peaks and an estimated number of peaks is not valid.

An apparatus for decoding a speech signal is also described. The apparatus includes means for obtaining a packet. The apparatus also includes means for obtaining a previous lag value. The apparatus further includes means for limiting the previous lag value if the previous lag value is greater than a maximum lag threshold. The apparatus additionally includes means for disallowing an adjustment to a number of synthesized peaks if a combination of the number of synthesized peaks and an estimated number of peaks is not valid.

The apparatus may include means for disallowing the adjustment to the number of synthesized peaks if an adjusted number of synthesized peaks is not within a maximum peak number threshold.

The apparatus may also include means for obtaining a current lag value. The apparatus may further include means for declaring the packet as a bad packet if the current lag value exceeds a transient mode lag threshold.

The apparatus may also include means for obtaining reserved bits from the packet. The apparatus may further include means for declaring the packet as a bad packet if at least one reserved bit is a non-zero bit.

The apparatus may include means for limiting the previous lag value if the previous lag value is less than a minimum lag threshold. The apparatus may include means for limiting a prototype pulse length to a maximum length. The apparatus may include means for limiting a difference in samples between two pulses in an excitation of a previous frame to a maximum difference threshold.

A method for encoding a speech signal is also described. The method includes obtaining a current transient frame. The method also includes determining a prototype pulse waveform. The method further includes limiting a difference in samples between two pulses in the prototype pulse waveform to a maximum difference threshold.

An electronic device for encoding a speech signal is also described. The electronic device includes framing circuitry configured to obtain a current transient frame. The electronic device also includes encoder circuitry configured to determine a prototype pulse waveform, and to limit a difference in samples between two pulses in the prototype pulse waveform to a maximum difference threshold.

A computer-program product for encoding a speech signal is also described. The computer-program product includes a non-transitory tangible computer-readable medium having instructions thereon. The instructions include code for causing an electronic device to obtain a current transient frame. The instructions also include code for causing the electronic device to determine a prototype pulse waveform. The instructions further include code for causing the electronic device to limit a difference in samples between two pulses in the prototype pulse waveform to a maximum difference threshold.

An apparatus for encoding a speech signal is also described. The apparatus includes means for obtaining a current transient frame. The apparatus also includes means for determining a prototype pulse waveform. The apparatus further includes means for limiting a difference in samples between two pulses in the prototype pulse waveform to a maximum difference threshold.

### BRIEF DESCRIPTION OF THE DRAWINGS

FIG. 1 is a block diagram illustrating one configuration of a transmitting electronic device and a receiving electronic device in which systems and methods for mitigating speech signal quality degradation may be implemented;

FIG. 2 is a flow diagram illustrating one configuration of a method for decoding a speech signal;

FIG. 3 is a block diagram illustrating one example of an electronic device in which systems and methods for encoding a speech signal may be implemented;

FIG. 4 is a block diagram illustrating one example of an electronic device in which systems and methods for decoding a speech packet may be implemented;

FIG. 5 is a flow diagram illustrating one configuration of a method for adjusting a number of synthesized peaks;

FIG. 6 is a flow diagram illustrating one configuration of a method for limiting a previous lag value;

FIG. 7 is a graph illustrating an example of a previous frame and a current frame;

FIG. 8 is a block diagram illustrating one configuration of a transient encoder in which systems and methods for mitigating speech signal quality degradation may be implemented;

FIG. 9 is a block diagram illustrating one configuration of a transient decoder in which systems and methods for mitigating speech signal quality degradation may be implemented;

FIG. 10 is a block diagram illustrating one configuration of a quarter-rate prototype pitch period (QPPP) decoder in which systems and methods for mitigating speech signal quality degradation may be implemented;

FIG. 11 illustrates various components that may be utilized in an electronic device; and

FIG. 12 illustrates certain components that may be included within a wireless communication device.

### DETAILED DESCRIPTION

The systems and methods disclosed herein may be applied to a variety of electronic devices. Examples of electronic devices include voice recorders, video cameras, audio players (e.g., Moving Picture Experts Group-1 (MPEG-1) or MPEG-2 Audio Layer 3 (MP3) players), video players, audio recorders, desktop computers/laptop computers, personal digital assistants (PDAs), gaming systems, etc. One kind of electronic device is a communication device, which may communicate with another device. Examples of communication devices include telephones, laptop computers, desktop computers, cellular phones, smartphones, wireless or wired modems, e-readers, tablet devices, gaming systems, cellular telephone base stations or nodes, access points, wireless gateways and wireless routers.

An electronic device or communication device may operate in accordance with certain industry standards, such as International Telecommunication Union (ITU) standards and/or Institute of Electrical and Electronics Engineers (IEEE) standards (e.g., Wireless Fidelity or “Wi-Fi” standards such as 802.11a, 802.11b, 802.11g, 802.11n and/or 802.11ac). Other examples of standards that a communication device may comply with include IEEE 802.16 (e.g., Worldwide Interoperability for Microwave Access or “WiMAX”), Third Generation Partnership Project (3GPP), 3GPP Long Term Evolution (LTE), Global System for Mobile Telecommunications (GSM), cdma2000 and others (where a communication device may be referred to as a User Equipment (UE), NodeB, evolved NodeB (eNB), mobile device, mobile station, subscriber station, remote station, access terminal, mobile terminal, terminal, user terminal, subscriber unit, etc., for example). cdma2000 is described in documents from an organization named “3rd Generation Partnership Project 2” (3GPP2). While some of the systems and methods disclosed herein may be described in terms of one or more standards, this should not limit the scope of the disclosure, as the systems and methods may be applicable to many systems and/or standards.

It should be noted that some communication devices may communicate wirelessly and/or may communicate using a wired connection or link. For example, some communication devices may communicate with other devices using an Ethernet protocol. The systems and methods disclosed herein may be applied to communication devices that communicate wirelessly and/or that communicate using a wired connection or link. In one configuration, the systems and methods disclosed herein may be applied to a communication device that communicates with another device using a satellite.

The systems and methods disclosed herein may be applied to one example of a communication system that is described as follows. In this example, the systems and methods disclosed herein may provide low bit rate (e.g., 2 kilobits per second (kbps)) speech encoding for geo-mobile satellite air interface (GMSA) satellite communication. More specifically, the systems and methods disclosed herein may be used in integrated satellite and mobile communication networks. Such networks may provide seamless, transparent, interoperable and ubiquitous wireless coverage. Satellite-based service may be used for communications in remote locations where terrestrial coverage is unavailable. For example, such service may be useful for man-made or natural disasters, broadcasting and/or fleet management and asset tracking. L and/or S-band (wireless) spectrum may be used.

In one configuration, a forward link may use 1x Evolution Data Optimized (EV-DO) Rev A air interface as the base technology for the over-the-air satellite link. A reverse link may use frequency-division multiplexing (FDM). For example, a 1.25 megahertz (MHz) block of reverse link spectrum may be divided into 192 narrowband frequency channels, each with a bandwidth of 6.4 kilohertz (kHz). The reverse link may use 1 FDM or 2 FDM channels and the reverse link data rate may be limited. This may present a need for low bit rate encoding. A 2 kbps vocoder can be used on any of the physical layer data rate channels either in 1 FDM or 2 FDM.

On the reverse link, for example, a low bit rate speech encoder may be used. This may allow a fixed rate of 2 kbps for active speech for a single FDM channel assignment on the reverse link. In one configuration, the reverse link uses a ¼ convolution coder for basic channel coding.

The systems and method disclosed herein may be used by a vocoder. For example, the vocoder may be an enhanced variable rate codecs (EVRC) vocoder operating in a low bit rate mode. In one configuration, the vocoder may be a service option 77 (SO77) EVRC vocoder as described in the 3GPP2 C.S0014-E v1.0 standard titled “Enhanced Variable Rate Codec, Speech Service Options 3, 68, 70, 73 and 77 for Wideband Spread Spectrum Digital Systems.” This vocoder may use a low bit rate mode (e.g., 2 kbps) when operating in capacity operating point number 3 (COP3). It should be noted, however, that the disclosed systems and methods should not be limited to an SO77 EVRC vocoder.

A vocoder may experience speech signal quality degradation when operating in bad packet or frame erasure conditions. In a bad rate situation, a vocoder may receive a packet (e.g., an encoded speech signal), but an incorrect rate may be detected. In addition, a vocoder may receive a packet that may contain errors. Therefore, a bad packet may be a packet with errors. For instance, a bad packet may have an incorrect rate and/or internal errors (e.g., bit errors). If not properly handled, a bad packet may result in a situation where the packet formed with one rate format ends up getting processed as a packet with another rate format, resulting in an erroneous output. Typically, a receiver includes an error detection module that detects a bad packet. However, some errors may not be detected due to the limitations of the error detection codes. Such errors may then get passed on to the decoder.

In a frame erasure situation, the vocoder may receive a corrupted packet that contains one or more bit errors. A vocoder may include mechanisms to detect corrupted packets. For example, a receiver may perform a cyclic redundancy check (CRC) on the received packet to identify frame errors. However, a corrupted packet may pass a CRC and may be passed to the decoder. The vocoder itself may not implement a CRC check. In some configurations, the CRC may be performed in the Physical layer/MAC (Medium Access Control) Layer.

Known solutions for handling these bad packet or frame erasure conditions include utilizing received parameters to detect a bad packet or an erased frame. For example, the vocoder may obtain parameters from the received packet and may search for invalid parameter combinations based on the packet format structure. If an invalid combination of parameters is detected, then the vocoder may declare an erasure of the frame and may perform erasure processing (e.g., the vocoder may use pitch information from previous frames to extrapolate for the current frame).

Despite these known approaches to identify bad packet and frame erasure conditions, a bad packet or an erased frame may still go undetected and may be passed to the decoder. Furthermore, even if detected, bad packet and frame erasure conditions may result in the decoder producing garbled speech, significant artifacts in the speech signal. Furthermore, bad packet and frame erasure conditions may result in instability or abnormality in software execution procedures, potentially causing catastrophic failure in software execution. The systems and methods disclosed herein may mitigate the effects of a bad packet or an erased frame on the quality of a speech signal.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

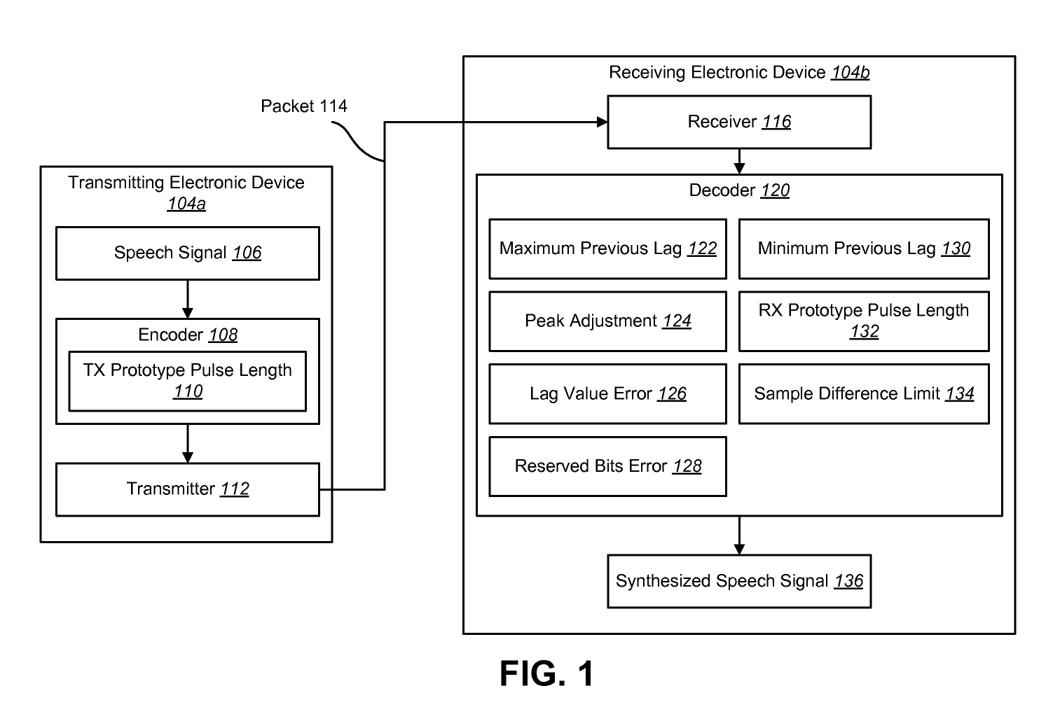

FIG. 1 is a block diagram illustrating one configuration of a transmitting electronic device 104a and a receiving electronic device 104b in which systems and methods for mitigating speech signal quality degradation may be implemented. The transmitting electronic device 104a and the receiving electronic device 104b may include a vocoder to process (e.g., encode and/or decode) a speech signal 106. In one configuration, the vocoder may be a SO77 EVRC vocoder operating in a low bit rate (e.g., COP3) mode.

The transmitting electronic device 104a may obtain a speech signal 106. In one configuration, the transmitting electronic device 104a obtains the speech signal 106 by capturing and/or sampling an acoustic signal using a microphone. In another configuration, the transmitting electronic device 104a receives the speech signal 106 from another device (e.g., a Bluetooth headset, a Universal Serial Bus (USB) drive, a Secure Digital (SD) card, a network interface, wireless microphone, etc.).

The transmitting electronic device 104a may segment the speech signal 106 into one or more frames (e.g., a sequence of frames). For instance, a frame may include a particular number of speech signal 106 samples and/or include an amount of time (e.g., 10-20 milliseconds) of the speech signal 106. When the speech signal 106 is segmented into frames, the frames may be classified according to the signal that they contain. For example, a frame may be a voiced frame, an unvoiced frame, a silent frame or a transient frame.

The speech signal 106 may be provided to an encoder 108. In one configuration, the encoder 108 may include different types of encoders to process (e.g., encode) the different types of frames. For example, the encoder 108 may include a silence encoder to encode a silent frame. A noise excited linear prediction (NELP) encoder may encode an unvoiced frame. A transient encoder may encode a transient frame. Additionally, a quarter-rate prototype pitch period (QPPP) encoder may encode a voiced frame.

The encoder 108 may encode frames of a speech signal 106 into a “compressed” format by estimating or generating a set of parameters that may be used to synthesize the speech signal 106. In one configuration, such parameters may represent estimates of pitch (e.g., frequency), amplitude and formants (e.g., resonances) that can be used to synthesize the speech signal 106. For example, depending on the frame type, the parameters may include a lag value (e.g., pitch lag), quantized linear predictive coding (LPC) coefficients, quantized gains, and/or frame type, among other parameters. The encoder 108 may include a transmit (TX) prototype pulse length block/module 110. TX prototype pulse length block/module 110 may limit the prototype pulse length generated by the encoder 108 to the maximum length.

In one configuration, the transmitting electronic device 104a may include a transmitter 112. The parameters may be provided to the transmitter 112. The transmitter 112 may format the parameters into a format suitable for transmission. For example, the transmitter 112 may encode, modulate, scale (e.g., amplify) and/or otherwise format the parameters as a packet 114. In some configurations, the packet 114 may also include header information, error correction information, routing information and/or other information in addition to payload data (e.g., the parameters). The transmitter 112 may transmit the packet 114 to another device, such as the receiving electronic device 104b. The packet 114 may be transmitted using a wireless and/or wired connection or link. In some configurations, the packet 114 may be relayed by satellite, base station, routers, switches and/or other devices or mediums to the receiving electronic device 104b.

The receiving electronic device 104b may obtain the packet 114 transmitted by the transmitting electronic device 104a using a receiver 116. The receiving electronic device 104b may unpack the packet 114 (e.g., perform de-packetization) and may provide the parameters to a decoder 120. In one configuration, the decoder 120 may be a voice decoder. The decoder 120 may include one or more types of decoders, such as a decoder for silent frames (e.g., a silence decoder), a decoder for unvoiced frames (e.g., a noise excited linear prediction (NELP) decoder), a transient decoder and/or a decoder for voiced frames (e.g., a quarter rate prototype pitch period (QPPP) decoder). A frame type parameter in the packet 114 may be used to determine which decoder (included in the decoder 120) to use. The decoder 120 may decode the encoded non-transient speech signal to produce a synthesized speech signal 136 that may be output (using a speaker after digital to analog conversion, for example), stored in memory and/or transmitted to another device (e.g., a Bluetooth headset, etc.).

The decoder 120 may include a maximum previous lag block/module 122, a peak adjustment block/module 124, a lag value error block/module 126, a reserved bits error block/module 128, a minimum previous lag block/module 130, a receive (RX) prototype pulse length block/module 132 and a sample difference limit block/module 134. As used herein, the term “block/module” may be used to indicate that a particular element may be implemented in hardware (e.g., circuitry), software or a combination of both.

The maximum previous lag block/module 122 may limit the lag value that is used by the decoder 120. The maximum previous lag block/module 122 may limit the lag value that is used for decoder processing of regular frames as well as erasure or bad packet processing. The lag value of the previous frame (e.g., the previous lag value) may be stored in memory and the decoder 120 may use that lag value instead of the lag value associated with the current frame. However, if the previous lag value exceeds the maximum lag threshold of the voiced decoder (e.g., the QPPP decoder), the voiced processing may fail. Therefore, the maximum lag threshold may be the maximum lag value that may be correctly processed by the voiced decoder. The term “previous lag value” may also be referred to as previous frame lag value.

As described above, a frame may be classified as a transient frame, a voiced frame, silent frame, and/or unvoiced frame. A transient frame may be further categorized as up-transient or down-transient. Up-transient may indicate a silence (or unvoiced) to voice transition and down-transient may indicate a voice to silence (or unvoiced) transition. During an up-transient situation, a voiced frame could immediately follow an up-transient frame. But in an up-transient situation, where an erased voiced frame follows the up-transient frame, the lag value of the transient frame may exceed the maximum lag threshold of the voiced decoder.

To prevent the decoder 120 from using a previous lag value that is out of range, the maximum previous lag block/module 122 may limit the previous lag value based on the decoding mode. For example, the maximum previous lag block/module 122 may detect that the previous lag value exceeds the maximum lag threshold for voiced decoding. The maximum previous lag block/module 122 may then limit the previous lag value used in voiced processing. In a bad packet or frame erasure situation (e.g., when the packet 114 is a bad packet or the current frame is an erased frame), the decoder 120 may use a previous lag value as input (for voiced erasure processing, for instance).

The peak adjustment block/module 124 may regulate an adjustment to the number of synthesized peaks. There are situations where erroneous frames are not detected as erasures and are provided to the decoder 120 for processing, which may result in erroneous output speech. This may cause artifacts in the synthesized speech signal 136 and may create discomfort to the user. In addition, processing one or more of these erroneous frames may result in catastrophic problems for the software implementation in the decoder 120. For example, if the receiving electronic device 104b is a phone, processing an erroneous frame may render the decoder 120 inoperative and/or may cause the call to be terminated.

Upon obtaining the parameters from the packet 114, the receiving electronic device 104b may derive additional parameters (e.g., derived parameters) from the received parameters and internally maintained state variables of the decoder 120. For example, the decoder 120 may detect range limits in these derived parameters and may restrict them to valid ranges to limit the effect of the derived parameters on further software processing. The decoder 120 may also look at two or more derived parameters and detect invalid combinations of these derived parameters to ensure that the subsequent processing is not given out of range input values.

The peak adjustment block/module 124 may regulate the adjustment to the number of synthesized peaks based on derived parameters. For example, the decoder 120 may determine a number of synthesized peaks of the current frame based on the parameters included in the packet 114. In one configuration, the number of synthesized peaks may be determined based on the pitch lag and the size of the frame. One approach to estimating the number of synthesized peaks is dividing the frame size by the pitch lag (e.g., framesize/pitchlag).

The decoder 120 may also determine an estimated number of peaks (e.g., pulses) in the current frame, which may be based on the current frame size and a lag value. In one configuration, the estimated number of peaks may be based on the current lag value. In another configuration, the estimated number of peaks may be based on the previous lag value or a combination of both the current and previous lag values. The estimated number of peaks, therefore, is a derived parameter that is an estimation of the number of peaks in the current frame based on the size of the current peak and the lag value.

The decoder 120 may then determine an adjustment to the number of synthesized peaks based on the estimated number of peaks. For example, the decoder 120 may take the difference between the estimated number of peaks and the number of synthesized peaks in the current frame and adjust the number of synthesized peaks by that difference. However, in a bad packet or frame erasure situation, the adjusted number of peaks (as determined by the decoder 120) may be out of the range that the decoder 120 can handle. If the current frame or a previous frame was an erased frame, or if the current packet 114 or a previous packet 114 was a bad packet, the adjusted number of peaks may be out of range.

To regulate the adjustment to the number of peaks, the peak adjustment block/module 124 may determine whether a combination of the number of synthesized peaks and the estimated number of peaks is valid. In one configuration, the peak adjustment block/module 124 may obtain a frame error protection value. The frame error protection value is a parameter that is the difference between the estimated number of peaks and the transmitted number of peaks. The frame error protection value may be transmitted. For example, the frame error protection value may be a parameter that is included in the packet 114. The peak adjustment block/module 124 may then evaluate whether the combination of the number of synthesized peaks and the estimated number of peaks is valid based on the frame error protection value. If the combination is not valid, the peak adjustment block/module 124 may not allow any adjustment to the number of synthesized peaks.

The peak adjustment block/module 124 may also determine whether an adjusted number of synthesized peaks (e.g., the number of peaks after adjustment) is within a maximum peak number threshold. In one configuration, the maximum peak number threshold is set by dividing the frame size by the pitch lag and adding a fixed value (e.g., framesize/pitchlag+fixedvalue(2)). In one configuration, the pitch lag may be a minimum value of pitch lag (e.g., a minimum pitch lag value supported by the transmitting electronic device 104a operating in transient mode). If the adjusted number of synthesized peaks is not within the maximum peak number threshold, then the peak adjustment block/module 124 may disallow an adjustment to the number of synthesized peaks and the decoder 120 may use the un-adjusted number of synthesized peaks. However, if the adjusted number of synthesized peaks is within the maximum peak number threshold, the peak adjustment block/module 124 may allow the adjustment to the number of synthesized peaks.

In one example, the number of peaks in a current frame is 9 and the maximum peak number threshold may be 10 peaks per frame. In a bad packet or frame erasure situation, however, the receiving electronic device 104b may determine that the adjusted number of peaks should be 12. Because the adjusted number of peaks is greater than the maximum peak number threshold, the peak adjustment block/module 124 may disallow an adjustment to the number of synthesized peaks, and the decoder 120 may synthesize 9 peaks.

The lag value error block/module 126 may determine whether a packet 114 that is detected to be in a transient mode is a bad packet. The receiving electronic device 104b may obtain a current lag value from the packet 114. The lag value error block/module 126 may determine whether the lag value exceeds a transient mode lag threshold. In one configuration, the transient mode lag threshold may be based on the range of lag values supported by the transmitting electronic device 104a when operating in transient mode (e.g., transient encoding). The transient mode lag threshold may be the maximum lag value supported by the transmitting electronic device 104a. To determine whether something modified the packet 114 during transmission, the lag error block/module 126 may check to see if the current lag value in the packet 114 exceeds the supported range of the transmitting electronic device 104a. The lag error block/module 126 may declare the packet 114 as a bad packet 114 if the current lag value exceeds the transient mode lag threshold. In one configuration, upon declaring the packet 114 as a bad packet 114, an erasure may be flagged, this packet 114 may be treated as lost and a frame erasure handling mechanism may replace the regular decoder 120.

The reserved bits error block/module 128 may determine whether a packet 114 is a bad packet. The receiving electronic device 104b may obtain reserved bits from the packet 114. The reserved bits may be unallocated bits included in the packet 114. It should be noted that reserved bits may not be present in the packet 114, but the presence of reserved bits may be conditioned on an independent coding flag being set.

Only a certain number of bits may be allocated to represent the parameters, which is less than a total number of available bits in the packet 114. The unallocated bits may be the reserved bits. In one configuration, when an independent coding flag is set in a transient packet 114, the reserved bits of the packet 114 are expected to be zero. Therefore, in an uncorrupted packet 114 the reserved bits are zero, but in a bad packet 114 the reserved bits may be non-zero. The reserved bits error block/module 128 may declare the packet 114 as a bad packet 114 if at least one reserved bit is a non-zero bit.

The minimum previous lag block/module 130 may limit the previous lag value to a minimum lag threshold. In the event that an erased frame is not detected and may be provided to the decoder 120, the minimum previous lag block/module 130 may determine whether a previous lag value is less than a minimum lag threshold. If the previous lag value is less than a minimum lag threshold, then the minimum previous lag block/module 130 may limit (e.g., set) the previous lag value to the minimum lag threshold.

The sample difference limit block/module 134 may limit the difference in samples between two pulses in an excitation of a previous frame to a maximum difference threshold. The receiving electronic device 104b may obtain input parameters from the packet 114 and may derive the distance between the two pitch positions of a previous frame based on the parameters. This distance may be represented as a sample difference (e.g., a number of samples) between two pulses in the excitation of the previous frame.

The sample difference limit block/module 134 may limit the sample difference to a maximum difference threshold corresponding to the supported range on the transmitter side. Therefore, if the sample difference is greater than the maximum difference threshold (due to a bad packet 114 or erased frame, for instance), the sample difference limit block/module 134 may limit (e.g., set) the sample difference to the maximum difference threshold. This operation may ensure that subsequent processing stages are not severely affected by a bad packet 114 or an erased frame.

The RX prototype pulse length block/module 132 may limit the prototype pulse length to a maximum length for frames detected as being in transient mode. As part of the decoding process, the decoder 120 may generate a prototype pulse waveform of a certain length (e.g., prototype pulse length) based on the parameters received in the packet 114. However, in a bad packet or frame erasure situation, the corrupted packet 114 may indicate a prototype pulse length that may be greater than the length supported by the transient decoding mode. The RX prototype pulse length block/module 132 may limit the prototype pulse length generated by the decoder 120 operating in transient decoding mode to a maximum length. To facilitate reliable operation of the RX prototype pulse length block/module 132, the encoder 108 of the transmitting electronic device 104a may include a TX prototype pulse length block/module 110. The TX prototype pulse length block/module 110 may limit the prototype pulse length generated by the encoder 108 to the maximum length supported by transient encoding.

It should be noted that for clarity, the transmitting electronic device 104a is shown with an encoder 108 and a transmitter 112, and the receiving electronic device 104b is shown with a receiver 116 and a decoder 120. In some configurations, however, a single electronic device 104 may perform both transmitting operations and receiving operations. Therefore, a single electronic device 104 may include both an encoder 108 and a decoder 120. Similarly, a single electronic device may include both a transmitter 112 and a receiver 116.

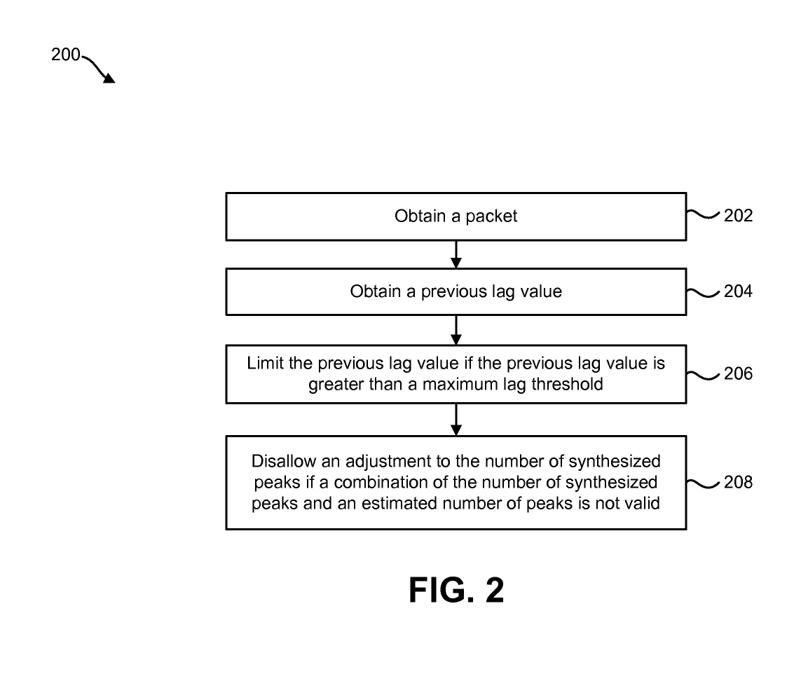

FIG. 2 is a flow diagram illustrating one configuration of a method 200 for decoding a speech signal 106. For example, an electronic device 104 may perform the method 200 illustrated in FIG. 2 in order to mitigate speech signal quality degradation. In one configuration, the electronic device 104 may be operating in a low bit rate mode under frame erasure or impaired channel conditions associated with a bad packet 114 or an erased frame.

The electronic device 104 may obtain 202 a packet 114. The packet 114 may be obtained 202 from another electronic device 104 (e.g., a transmitting electronic device 104) that encoded a speech signal 106. The packet 114 may include parameters based on the encoded speech signal 106 that may be used to produce a synthesized speech signal 136. The packet 114 may be a bad packet 114 or may include an erased frame.

The electronic device 104 may obtain 204 a previous lag value. In one configuration, if the electronic device 104 obtains 202 a bad packet 114 or if the current frame (included in the packet 114) is an erased frame, the electronic device 104 may perform erasure decoding. As part of the erasure decoding, the electronic device 104 may obtain 204 a previous lag value to use instead of the current lag value. For example, the lag value of the previous frame may be stored in memory and the electronic device 104 may use that previous lag value instead of the lag value associated with the current frame for erasure decoding.

The electronic device 104 may limit 206 the previous lag value if the previous lag value is greater than a maximum lag threshold. The electronic device 104 may limit 206 the previous lag value that is used in erasure processing. In one configuration, an up-transient frame typically indicates a transition from silence (or unvoiced speech) to voice in the speech signal. The up-transient frame may immediately precede a voiced frame (e.g., an erased voiced frame in some cases). The electronic device 104 may perform voiced erasure decoding using the previous lag value obtained from the up-transient frame. To prevent the electronic device 104 from using a previous lag value that is out of range of the voiced decoder (e.g., the QPPP decoder), the electronic device 104 may limit 206 the previous lag value to a maximum lag threshold. For instance, the previous lag value may be 140 samples (that corresponds to the up-transient frame, for example), but the electronic device 104 may limit 206 the previous lag value to a maximum lag threshold of 120 samples for erasure processing of the voiced decoder.

The electronic device 104 may disallow 208 an adjustment to a number of synthesized peaks if a combination of the number of synthesized peaks and an estimated number of peaks is not valid. The electronic device 104 may determine the number of synthesized peaks of the current frame based on the parameters included in the packet 114. The electronic device 104 may also determine an estimated number of peaks (e.g., pulses) in the current frame, which may be based on the current frame size and a lag value.

The electronic device 104 may then determine an adjustment to the number of synthesized peaks based on the estimated number of peaks. In one configuration, the adjustment may be based on the difference between the estimated number of peaks and the actual number of peaks in the current frame. However, a bad packet 114 or an erased frame may result in an out of range adjustment. For instance, the estimated number of peaks or the number of synthesized peaks in the current frame may be incorrectly derived if a current or previous packet 114 is a bad packet 114 or has an erased frame. Therefore, an adjustment based on these incorrect values may be out of range for the decoder 120.

The electronic device 104 may determine whether the combination of the number of synthesized peaks and the estimated number of peaks is valid. In one configuration, the electronic device 104 may obtain a frame error protection value. The electronic device 104 may then evaluate whether the combination of the number of synthesized peaks and the estimated number of peaks is valid based on the frame error protection value. If the combination is not valid, the electronic device 104 may disallow 208 the adjustment to the number of synthesized peaks.

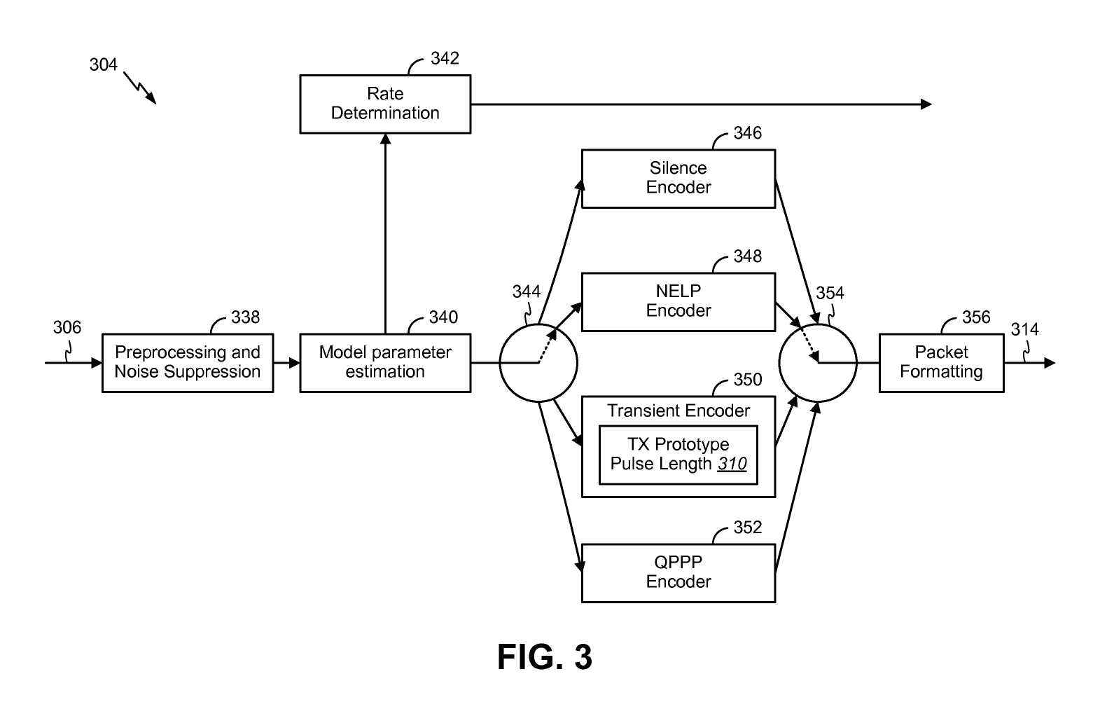

FIG. 3 is a block diagram illustrating one example of an electronic device 304 in which systems and methods for encoding a speech signal 306 may be implemented. In this example, the electronic device 304 includes a preprocessing and noise suppression block/module 338, a model parameter estimation block/module 340, a rate determination block/module 342, a first switching block/module 344, a silence encoder 346, a noise excited (or excitation) linear predictive (or prediction) (NELP) encoder 348, a transient encoder 350, a quarter-rate prototype pitch period (QPPP) encoder 352, a second switching block/module 354 and a packet formatting block/module 356.

The preprocessing and noise suppression block/module 338 may obtain or receive a speech signal 306. In one configuration, the preprocessing and noise suppression block/module 338 may suppress noise in the speech signal 306 and/or perform other processing on the speech signal 306, such as filtering. The resulting output signal is provided to a model parameter estimation block/module 340.

The model parameter estimation block/module 340 may estimate LPC coefficients through linear prediction analysis, estimate a first approximation pitch lag and estimate the autocorrelation at the first approximation pitch lag. The rate determination block/module 342 may determine a coding rate for encoding the speech signal 306. The coding rate may be provided to a decoder for use in decoding the (encoded) speech signal 306.

The electronic device 304 may determine which encoder to use for encoding the speech signal 306. It should be noted that, at times, the speech signal 306 may not always contain actual speech, but may contain silence and/or noise, for example. In one configuration, the electronic device 304 may determine which encoder to use based on the model parameter estimation 340. For example, if the electronic device 304 detects silence in the speech signal 306, it 304 may use the first switching block/module 344 to channel the (silent) speech signal through the silence encoder 346. The first switching block/module 344 may be similarly used to switch the speech signal 306 for encoding by the NELP encoder 348, the transient encoder 350 or the QPPP encoder 352, based on the model parameter estimation 340.

The silence encoder 346 may encode or represent the silence with one or more pieces of information. For instance, the silence encoder 346 could produce a parameter that represents the length of silence in the speech signal 306.

The “noise-excited linear predictive” (NELP) encoder 348 may be used to code frames classified as unvoiced speech. NELP coding operates effectively, in terms of signal reproduction, where the speech signal 306 has little or no pitch structure. More specifically, NELP may be used to encode speech that is noise-like in character, such as unvoiced speech or background noise. NELP uses a filtered pseudo-random noise signal to model unvoiced speech. The noise-like character of such speech segments can be reconstructed by generating random signals at the decoder and applying appropriate gains to them. NELP may use a simple model for the coded speech, thereby achieving a lower bit rate.

The transient encoder 350 may be used to encode transient frames in the speech signal 306 in accordance with the systems and methods disclosed herein. For example, the electronic device 304 may use the transient encoder 350 to encode the speech signal 306 when a transient frame is detected.

To mitigate the effects of a bad packet 314 or erased frame at the decoder 120, the transient encoder 350 may include a TX prototype pulse length block/module 310. The transient encoder 350 may obtain a current transient frame (from framing circuitry, for example). The transient encoder 350 may determine a prototype pulse waveform with a certain prototype pulse length. The TX prototype pulse length block/module 310 may limit the prototype pulse length generated by the transient encoder 350 to the maximum length supported by the transient encoding mode. For example, when the transient encoder 350 is processing in a low bit rate (e.g., 2 kbps) mode, the TX prototype pulse length block/module 310 may limit the prototype pulse length to 160 samples. Listing (1) illustrates one example of code to implement this operation.

SATURATE_PARAM(proto_length, 160) in gen_proto_fx( ) Listing (1)

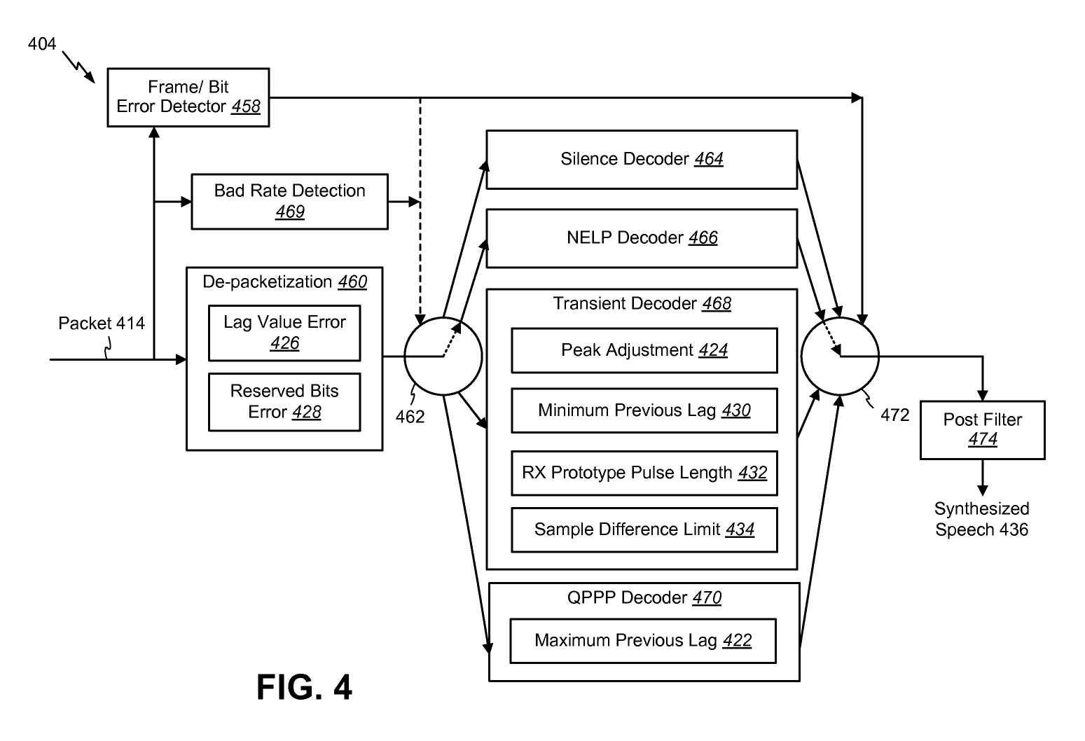

In Listing (1), the proto_length is the prototype pulse length that may be set to 160 samples. The prototype pulse length may also be limited in decoder processing by a transient decoder, as described below in connection with FIG. 4.

The quarter-rate prototype pitch period (QPPP) encoder 352 may be used to code frames classified as voiced speech. Voiced speech contains slowly time varying periodic components that are exploited by the QPPP encoder 352. The QPPP encoder 352 codes a subset of the pitch periods within each frame. The remaining periods of the speech signal 306 are reconstructed by interpolating between these prototype periods. By exploiting the periodicity of voiced speech, the QPPP encoder 352 is able to reproduce the speech signal 306 in a perceptually accurate manner.

The QPPP encoder 352 may use Prototype Pitch Period Waveform Interpolation (PPPWI), which may be used to encode speech data that is periodic in nature. Such speech is characterized by different pitch periods being similar to a “prototype” pitch period (PPP). This PPP may be voice information that the QPPP encoder 352 uses to encode. A decoder 120 can use this PPP to reconstruct other pitch periods in the speech segment.

The second switching block/module 354 may be used to channel the (encoded) speech signal from the encoder 346, 348, 350, 352 that is currently in use to the packet formatting block/module 356. The packet formatting block/module 356 may format the (encoded) speech signal 306 into one or more packets 314 (for transmission, for example). For instance, the packet formatting block/module 356 may format a packet 314 for a transient frame. In one configuration, the one or more packets 314 produced by the packet formatting block/module 356 may be transmitted to another device.

FIG. 4 is a block diagram illustrating one example of an electronic device 404 in which systems and methods for decoding a speech packet 414 may be implemented. In this example, the electronic device 404 includes a frame/bit error detector 458, a de-packetization block/module 460, a bad rate detection block/module 469, a first switching block/module 462, a silence decoder 464, a noise excited linear predictive (NELP) decoder 466, a transient decoder 468, a quarter-rate prototype pitch period (QPPP) decoder 470, a second switching block/module 472 and a post filter 474. The electronic device 404 may also include a CELP decoder (not shown) for decoding half rate or full rate packets.

It should be noted that each block illustrated in FIG. 4 is assumed to contain relevant erasure processing, if applicable. Furthermore, excitation signals generated by each of the decoders described in connection with FIG. 4 and their extrapolation to synthesized speech 436 is assumed to be part of each decoder.

The electronic device 404 may obtain a packet 414. The packet 414 may be provided to the frame/bit error detector 458, the de-packetization block/module 460 and the bad rate detection block/module 469. The de-packetization block/module 460 may “unpack” information from the packet 414. For example, a packet 414 may include header information, error correction information, routing information and/or other information in addition to payload data. The de-packetization block/module 460 may extract the payload data from the packet 414. The de-packetization block/module 460 may also extract parameters for each packet 414 depending upon the rate and mode in which the transmitter encoded that packet 414. The payload data may be provided to the first switching block/module 462.

The de-packetization block/module 460 may include a lag error block/module 426 and a reserved bits error block/module 428 to identify a bad packet 414. In one configuration, the lag error block/module 426 and reserved bits error block/module 428 may identify bad transient codec packets 414. A packet 414 may be received correctly, but an incorrect rate may be detected. If not properly handled, this can result in a situation where the packet 414 formed with one rate format ends up getting processed as a packet 414 with another rate format, resulting in an erroneous output. A packet 414 may contain parameter representations of various speech signal characteristics in quantized/un-quantized form. The lag error block/module 426 and the reserved bits error block/module 428 may reject bad packets 414 (e.g., bad transient mode packets) based on identifying parameters that are outside a certain range.

The lag error block/module 426 may identify a bad packet 414 based on a current lag value. The lag error block/module 426 may obtain the current lag value from the packet 414. The lag error block/module 426 may declare the packet 414 as a bad packet 414 if the current lag value exceeds a transient mode lag threshold (e.g., a maximum lag threshold in transient mode). Listing (2) illustrates one example of code to implement this operation.

Listing (2)

if(data_packet.PULSE_LAG > (MAXLAG_2KBPS_TRMODE-20)
declare BAD_RATE

In Listing (2), MAXLAG_{—}2KBPS_TRMODE is the transient mode lag threshold for transient decoding in a low bit rate (e.g., 2 kbps) mode. In one implementation, MAXLAG_{—}2KBPS_TRMODE may be set to 140 (e.g., 140 samples). Upon declaring the packet 414 as a bad packet 414, a frame erasure handling mechanism may then replace the regular decoding. It should be noted that pitch lag values may vary from 20 to 140. Therefore, in Listing (2) 20 is subtracted from the maximum lag threshold (e.g., MAXLAG_{—}2KBPS_TRMODE) so that the range is from 0 to 120. This range may be quantized using 7 bits (e.g., 0 to 127).

The reserved bits error block/module 428 may determine whether a packet 414 is a bad packet 414. In one configuration, the reserved bits error block/module 428 may obtain reserved bits from the packet 414. When an independent coding flag is set in a transient packet 414, the reserved bits of the packet 414 are expected to be zero. The reserved bits error block/module 428 may declare the packet 414 as a bad packet 414 if any of the reserved bits are non-zero bits. Listing (3) illustrates one example of code to implement this operation. Upon declaring the packet 414 as a bad packet 414, a frame erasure handling mechanism may then replace the regular decoding.

Listing (3)

if ( (trans_model_dec.indep_coding_flag == 1) && (reserved != 0) )
BAD_RATE=1;

The frame/bit error detector 458 may detect whether part or all of the packet 414 was received incorrectly. For example, the frame/bit error detector 458 may use an error detection code (sent with the packet 414) to determine whether any of the packet 414 was received incorrectly. In some configurations, the electronic device 404 may control the first switching block/module 462 and/or the second switching block/module 472 based on whether some or all of the packet 414 was received incorrectly, which may be indicated by the frame/bit error detector 458 output.

The bad rate detection block/module 469 may detect whether a rate associated with the packet 414 is incorrect (e.g., bad rate). In some configurations, the electronic device 404 may control the first switching block/module 462 and/or the second switching block/module 472 based on detecting a bad rate, which may be indicated by the bad rate detection block/module 469 output.

The packet 414 may include information (e.g., bits) that indicates which type of decoder should be used to decode the payload data. For example, an encoding electronic device 304 may send two bits that indicate the encoding mode. The (decoding) electronic device 404 may use this indication to control the first switching block/module 462 and the second switching block/module 472. This information may be specific to distinguishing QPPP decoder 470 and transient decoder 468 in quarter rate packets. Other rate packets might have other modes.

The electronic device 404 may thus use the silence decoder 464, the NELP decoder 466, the transient decoder 468 or the QPPP decoder 470 to decode the payload data from the packet 414. An excitation signal may be generated and then the synthesized speech signal 436 can be generated using the excitation. The synthesized speech signal 436 may then be provided to the second switching block/module 472, which may route the decoded data to the post filter 474. The post filter 474 may perform some filtering on the decoded data and output a synthesized speech signal 436.

The packet 414 may indicate the encoding mode of the packet 414 using a packet size, rate and/or encoded mode indicator. In general, at the receiver, the size of the packet 414 is used to determine rate. The packet 414 may also include bits used to identify the encoding mode. For silence, there is no encoding mode indicator, but the size of the packet 414 is used to determine the encoded rate that a silence encoder 346 used to encode the payload data.

The electronic device 404 may control the first switching block/module 462 to route the payload data to the silence decoder 464. The decoded (silent) payload data may then be provided to the second switching block/module 472, which may route the decoded payload data to the post filter 474. In another example, the NELP decoder 466 may be used to decode a speech signal (e.g., unvoiced speech signal) that was encoded by a NELP encoder 348.

In yet another example, the packet 414 may indicate that the payload data was encoded using a transient encoder 350 (using an encoding mode indicator, for example). Thus, the electronic device 404 may use the first switching block/module 462 to route the payload data to the transient decoder 468. In another example, the QPPP decoder 470 may be used to decode a speech signal (e.g., voiced speech signal) that was encoded by a QPPP encoder 352.

There are situations where the received packet 414 may pass a CRC, but it is still a corrupted or bad packet 414. In this case the frame/bit error detector 458 (using a de-jitter buffer, for instance) may not declare erasure, and may end up passing the packet 414 for decoding. Without some sort of protection, the decoder 120 processing the packet 414 with errors may generate an erroneous synthesized speech signal 436, resulting in an audible artifact for the user and drastically reducing the quality of speech. In addition, because the decoder 120 may maintain states, the corrupted or bad packet 414 may end up affecting these states, and may impact the speech output in subsequent frames, even if subsequent packets 414 are received without error. Furthermore, in low bit rate (e.g., 2 kbps) mode, an 8-bit CRC may be used, which may increase the chances of passing a corrupted or bad packet 414 relative to a 16-bit, or larger bit, length CRC.

To mitigate the effects of a bad packet 414 or an erased frame, the transient decoder 468 may include a peak adjustment block/module 424, a minimum previous lag block/module 430, an RX prototype pulse length block/module 432 and a sample difference limit block/module 434.

The peak adjustment block/module 424 may regulate the adjustment to the number of synthesized peaks in a current frame. The peak adjustment block/module 424 may determine the number of synthesized peaks of the current frame based on the parameters included in the packet 414. The peak adjustment block/module 424 may also determine an estimated number of peaks in the current frame, which may be based on the current frame size and the lag value.

The peak adjustment block/module 424 may then determine an adjustment to the number of synthesized peaks based on the estimated number of peaks. In one configuration, the peak adjustment block/module 424 may take the difference between the estimated number of peaks and the actual number of peaks in the current frame. The adjustment to the number of synthesized peaks may be this difference. For example, if the estimated number of peaks is 10 but the actual number of synthesized peaks in the current frame is 8, then the proposed adjustment is 2. However, a bad packet 414 or an erased frame may result in an incorrect (or out of range) adjustment. For instance, the estimated number of peaks or the number of peaks in the current frame may be incorrectly derived if a current or previous packet 414 is a bad packet 414 or has an erased frame, which may result in an erroneous adjustment.

To mitigate the effects of an erroneous adjustment, the peak adjustment block/module 424 may determine whether the combination of the number of synthesized peaks and the estimated number of peaks is valid. In one configuration, the peak adjustment block/module 424 may obtain a frame error protection value. The peak adjustment block/module 424 may then evaluate whether the combination of the number of synthesized peaks and the estimated number of peaks is valid based on the frame error protection value. If the combination is not valid, the peak adjustment block/module 424 may disallow an adjustment to the number of synthesized peaks.

The peak adjustment block/module 424 may also determine whether an adjusted number of synthesized peaks (e.g., the number of peaks after adjustment) is within a maximum peak number threshold. If the adjusted number of synthesized peaks is not within the maximum peak number threshold, then the peak adjustment block/module 424 may disallow an adjustment to the number of synthesized peaks, and the transient decoder 468 may use the un-adjusted number of synthesized peaks. However, if the adjusted number of synthesized peaks is within the maximum peak number threshold, the peak adjustment block/module 424 may allow the adjustment to the number of synthesized peaks. Listing (4) illustrates one example of code to implement a peak adjustment operation.

Listing (4)

```
Word16 check_misestim_numpks_fx(Word16 lag,
      Word16 num_syn_pk, Word16 feval)
{
      Word16 i, estim_num_pulses, rem, adj;
      estim_num_pulses=div_int_sp(FrameSize,lag,rem);
      if(sub(shl(rem,1),lag)>=0)
            estim_num_pulses=add(estim_num_pulses,1);
      if( ((feval==3) && (estim_num_pulses <= num_syn_pk)) ||
              ((feval==0) &&
              (estim_num_pulses >= (num_syn_pk_-1))) ||
              ((feval==1) && (estim_num_pulses >= num_syn_pk)) )
      {
            return(0);
      }
      i=sub(estim_num_pulses,sub(feval,2));
      adj=sub(i,num_syn_pk);
      if( (add(num_syn_pk,adj) <= MAX_SYN_PULSES) &&
            (add(num_syn_pk,adj) > 0) && (adj!=0) )
      {
            return(adj);
      }
      else
      return(0);
}
```

In Listing (4), num_syn_pk is the number of synthesized peaks, estim_num_pulses is the estimated number of peaks, lag is the lag value, feval is the frame error protection value, adj is the adjustment and MAX_SYN_PULSES is the maximum peak number threshold. In one implementation, MAX_SYN_PULSES may be set to 10. Therefore, the peak adjustment block/module 424 may allow the adjustment to the number of synthesized peaks if the combination is valid and the adjusted number of synthesized peaks does not exceed 10.

The minimum previous lag block/module 430 may determine whether a previous lag value used by the transient decoder 468 is less than a minimum lag threshold. If the previous lag value is less than a minimum lag threshold, then the minimum previous lag block/module 430 may limit (e.g., set) the previous lag value to the minimum lag threshold. In one implementation, the minimum lag threshold may be 20 samples. Listing (5) illustrates one example of code to implement this operation.

if(pdelayD_{—}fx<20) pdelayD_{—}fx=20; Listing (5)

In Listing (5), pdelayD_fx is the previous lag value that may be obtained from a previous packet 414. In this example, if a previous lag value is less than 20, then the previous lag value is set to 20.

The RX prototype pulse length block/module 432 may limit the prototype pulse length to a maximum length when in a low bit rate transient processing mode. The RX prototype pulse length block/module 432 may limit the prototype pulse length generated by the transient decoder 468 to a maximum length. For example, when the transient decoder 468 is processing in a low bit rate (e.g., 2 kbps) mode, the RX prototype pulse length block/module 432 may limit the prototype pulse length to 160 samples. Listing (6) illustrates one example of code to implement this operation.

SATURATE_PARAM(proto_length, 160) in gen_proto_{—}fx( ) Listing (6)

In Listing (6), the proto_length is the prototype pulse length that may be set to 160 samples. The prototype pulse length may also be limited in encoder processing by the transient encoder 350, as described above in connection with FIG. 3.

The sample difference limit block/module 434 may limit the maximum sample difference between two peaks (e.g., pulses) in the excitation of the previous frame. The sample difference limit block/module 434 may limit the location of the peak in the current frame based on the peak location in the previous frame and the maximum pitch lag. In one configuration, when the transient decoder 468 is operating in a low bit rate mode, the sample difference limit block/module 434 may limit the sample difference to a maximum difference threshold corresponding to the supported range on the transmitter side. In one implementation, the maximum difference threshold may be 140 samples. Listing (7) illustrates one example of code to implement this operation.

SATURATE_PARAM(prev_frame_{—}fx.diffloc,MAXLAG_{—}2KBPS_TRMODE) Listing (7)

In Listing (7), MAXLAG_{—}2KBPS_TRMODE is the maximum difference threshold for a low bit rate transient decoding mode. In one implementation, MAXLAG_{—}2KBPS_TRMODE may be set to 140 samples.

To mitigate the effects of a bad packet 414 or an erased frame on voiced decoding, the QPPP decoder 470 may include a maximum previous lag block/module 422. The maximum previous lag block/module 422 may limit the previous lag value that is used in erasure processing. During an up-transient, an unvoiced (up-transient) frame may precede an erased voiced frame. The QPPP decoder 470 may perform voiced erasure decoding using the previous lag value obtained from the up-transient frame. To prevent the QPPP decoder 470 from using a previous lag value that is out of range of the QPPP decoder 470, the maximum previous lag block/module 422 may limit the previous lag value to a maximum lag threshold. In one implementation, the maximum lag threshold may be 120 samples. Listing (8) illustrates one example of code to implement this operation.

if(pdelayD_{—}fx>MAXLAG) pdelayD_{—}fx=MAXLAG; Listing (8)

In Listing (8), pdelayD_fx is the previous lag value and MAXLAG is the maximum lag threshold for QPPP voice decoding. In one implementation, MAXLAG may be set to 120 samples.

The decoded data may be provided to the second switching block/module 472, which may route it to the post filter 474. The post filter 474 may perform some filtering on the signal, which may be output as a synthesized speech signal 436. The synthesized speech signal 436 may then be stored, output (after digital to analog conversion, using a speaker, for example) and/or transmitted to another device (e.g., a Bluetooth headset).

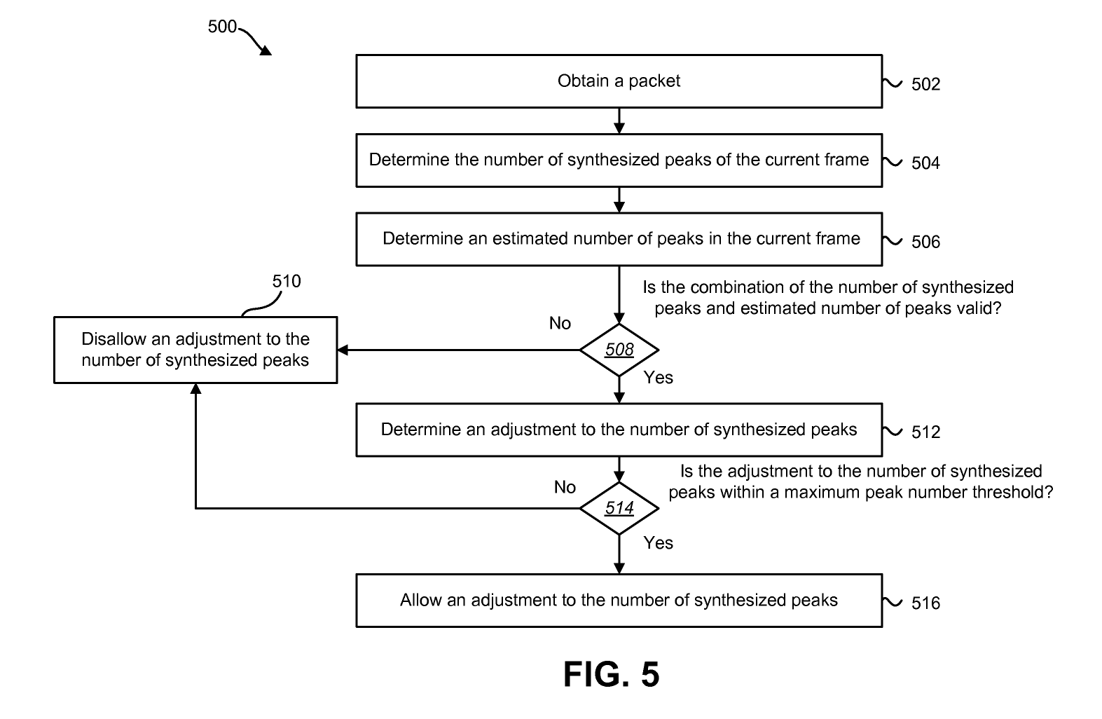

FIG. 5 is a flow diagram illustrating one configuration of a method 500 for adjusting a number of synthesized peaks. The method 500 may be performed during transient decoding. In this configuration, an electronic device 104 (that includes a transient decoder 468, for example) may obtain 502 a packet 114. The packet 114 may be obtained 502 from a transmitting electronic device 104a that encoded a speech signal 106. The packet 114 may include parameters (e.g., the encoded speech signal 106) that may be used to produce a synthesized speech signal 136. The packet 114 may also include header information, error correction information, routing information and/or other information in addition to payload data (e.g., the parameters). The packet 114 may be a bad packet 114 or may include an erased frame.

The electronic device 104 may determine 504 the number of synthesized peaks of the current frame. For example, the electronic device 104 may determine the number of synthesized peaks of the current frame based on the parameters included in the packet 114.

The electronic device 104 may determine 506 an estimated number of peaks in the current frame. For example, the electronic device 104 may determine the size (e.g., length) of the current frame. The electronic device 104 may then determine 506 the estimated number of peaks based on the current frame size and the current lag value, which may be obtained from the packet 114.

The electronic device 104 may determine 508 whether the combination of the number of synthesized peaks and the estimated number of peaks is valid. In one configuration, the electronic device 104 may obtain a frame error protection value. The electronic device 104 may then evaluate whether the combination of the number of synthesized peaks and the estimated number of peaks is valid based on the frame error protection value. In one scenario, if the frame error protection value is 3 and the estimated number of peaks is less than or equal to the number of synthesized peaks, then the combination is invalid. In another scenario, if the frame error protection value is 0 and the estimated number of peaks is greater than or equal to the number of synthesized peaks minus 1, then the combination is invalid. In yet another scenario, if the frame error protection value is 1 and the estimated number of peaks is greater than or equal to the number of synthesized peaks, then the combination is invalid. If the combination is not valid, the electronic device 104 may disallow 510 the adjustment to the number of synthesized peaks.

If the electronic device 104 determines 508 that the combination is valid, then the electronic device 104 may determine 512 an adjustment to the number of synthesized peaks. In one configuration, the adjustment may be based on the difference between the estimated number of peaks and the actual number of synthesized peaks in the current frame. If the number of synthesized peaks in the current frame does not match the estimated number of peaks, the adjustment may be the difference between the estimated number of peaks and the number of synthesized peaks.

The electronic device 104 may determine 514 whether the adjustment to the number of synthesized peaks is within (e.g., less than or equal to) a maximum peak number threshold. If the adjustment to the number of synthesized peaks is not within the maximum peak number threshold, then the electronic device 104 may disallow 510 the adjustment to the number of synthesized peaks. The electronic device 104 may disallow 510 any negative adjustment that makes the number of synthesized peaks after adjustment to be less than or equal to zero. However, if the electronic device 104 determines 514 that the adjusted number of synthesized peaks is within the maximum peak number threshold, then the electronic device 104 may allow 516 the adjustment to the number of synthesized peaks.

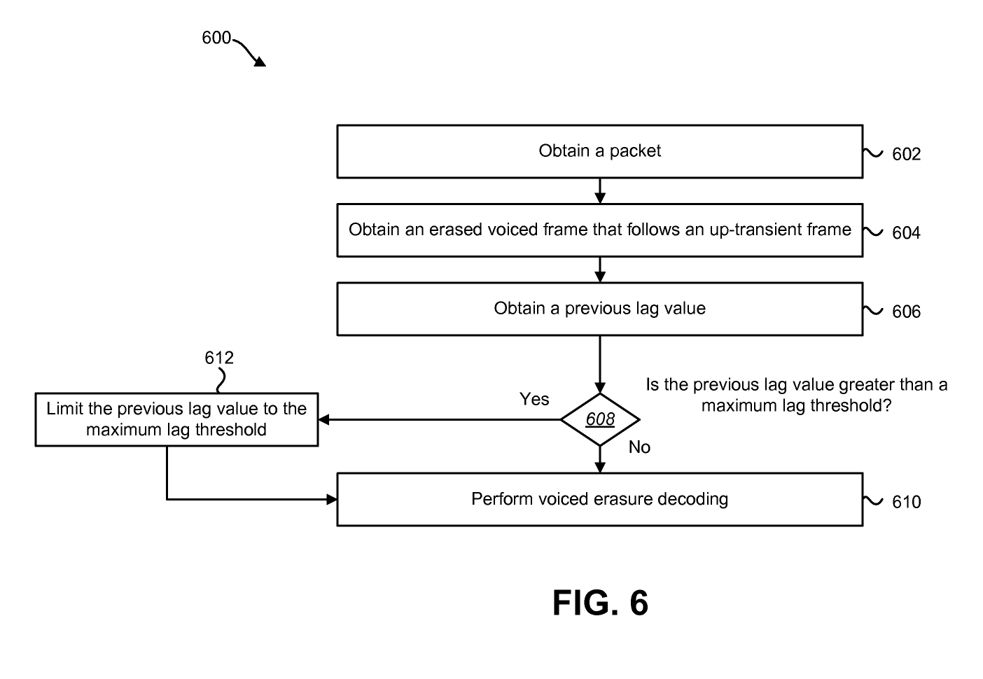

FIG. 6 is a flow diagram illustrating one configuration of a method 600 for limiting a previous lag value. The method 600 may be performed during transient decoding. In this configuration, an electronic device 104 (that includes a transient decoder 468, for example) may obtain 602 a packet 114. The packet 114 may be obtained 602 from a transmitting electronic device 104a that encoded a speech signal 106. The packet 114 may include parameters (e.g., the encoded speech signal 106) that may be used to produce a synthesized speech signal 136. The packet 114 may also include header information, error correction information, routing information and/or other information in addition to payload data (e.g., the parameters). The packet 114 may be a bad packet 114 or may include an erased frame.

The electronic device 104 may obtain 604 an erased voiced frame that follows an up-transient frame. In one configuration, during an up-transient (a silence (or unvoiced) to voice transition), an unvoiced (up-transient) frame may precede an erased voiced frame. The electronic device 104 may determine that the current frame is a voiced frame (based on a frame type parameter obtained from the packet 114, for instance.) The electronic device 104 may also determine that the current frame is an erased frame. In one configuration, the electronic device 104 may determine that the current frame is an erased frame if the current frame does not pass a CRC or other frame error check. In another configuration, if the electronic device 104 determines that the packet 114 is a bad packet, the electronic device 104 may perform erasure decoding.

The electronic device 104 may obtain 606 a previous lag value. In one configuration, if the electronic device 104 obtains 602 a bad packet 114 or if the current frame (included in the packet 114) is an erased frame, the electronic device 104 may perform erasure decoding. The electronic device 104 may obtain 606 a previous lag value to use during erasure decoding instead of the current lag value. For example, the lag value of the previous frame may be stored in memory and the electronic device 104 may use that previous lag value instead of the lag value associated with the current frame.

The electronic device 104 may determine 608 whether the previous lag value is greater than a maximum lag threshold. The maximum lag threshold may be the maximum lag value that the QPPP decoder 470 can process accurately. In one implementation, the maximum lag threshold for the QPPP decoder 470 may be 120 samples. However, because the voiced frame follows an up-transient frame, the previous lag value may be greater than the maximum lag threshold (because a transient decoder 468 may be able to handle greater lag values than the QPPP decoder 470). If the previous lag value is not greater than the maximum lag threshold (of the QPPP decoder 470), then the electronic device 104 may perform 610 voiced erasure decoding using the previous lag value.

If the electronic device 104 determines 608 that the previous lag value is greater than the maximum lag threshold, then the electronic device 104 may limit 612 the previous lag value to the maximum lag threshold. For instance, the previous lag value may be 140 samples, but the electronic device 104 may limit 608 the previous lag value to 120 samples (e.g., the maximum lag threshold supported by QPPP voiced decoder erasure processing). The electronic device 104 may then perform 610 voiced erasure decoding using this limited previous lag value.

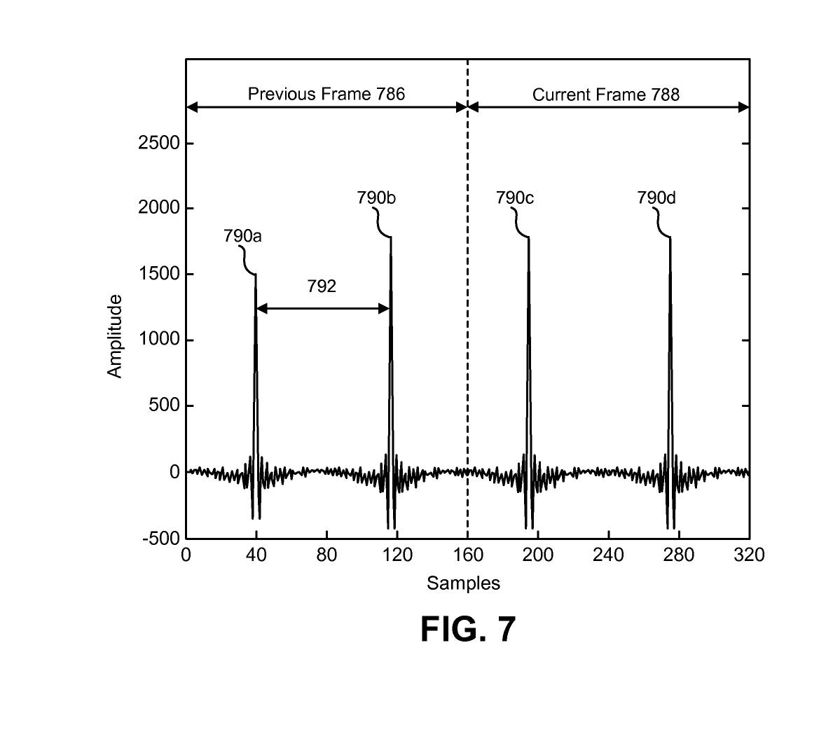

FIG. 7 is a graph illustrating an example of a previous frame 786 and a current frame 788. In the example illustrated in FIG. 7, the graph illustrates a previous frame 786 and a current frame 788 that may be used according to the systems and methods disclosed herein. The waveform illustrated within the current frame 788 may be an example of the residual signal of the current frame 788. The waveform illustrated within the previous frame 786 may be an example of a residual signal of the previous frame 786. The waveforms may include peaks 790a-d (e.g., a pulse, pitch or pitch spike). In the example illustrated in FIG. 7, an electronic device 104 may use the systems and methods disclosed herein to mitigate speech signal quality degradation.

In one scenario, the current frame 788 may be a transient frame, and the electronic device 104 may be in a transient decoder mode. When decoding a transient frame, the transient decoder 468 may synthesize the waveform of the current frame 788 based on the waveform of the previous frame 786. For example, the transient decoder 468 may estimate the location of the peaks 790c-d in the current frame 788 based on the location of the peaks 790a-b in the previous frame 786 and the lag value (e.g., pitch lag) of the previous frame 786 and/or the current frame 788. The lag value may be the distance 792 between peaks. For instance, as illustrated in FIG. 7, the previous lag value (e.g., the lag value of the previous frame 786) may be the distance 792 between the last peak 790b and the first peak 790a of the previous frame 786. The distance 792 may be expressed as the difference in samples between the peaks 790a-b. It should be noted, that if the previous frame 786 has more than two peaks 790, the previous lag value would be less than the distance 792 between the last peak 790b and the first peak 790a.

In a bad packet or frame erasure situation, the previous frame 786 or the current frame 788 (or both) may be corrupted due to a bad packet 114 or an erased frame. In this situation, the parameters associated with the previous frame 786 may be corrupted due to bad packet or frame erasure. Therefore, if the transient decoder 468 synthesizes the waveform of the current frame 788 based on the corrupted parameters of the previous frame 786, the synthesized speech signal quality may be poor.

To mitigate the impact of a bad packet 114 or an erased frame on the synthesized speech signal quality, the electronic device 104 may limit the sample difference between the last peak 790b and the first peak 790a of the previous frame 786. In one implementation, the sample difference may be limited to a maximum difference threshold corresponding to the supported range on the transmitter side. For example, the maximum difference threshold may be 140 samples. Therefore, if a bad packet 114 or erased frame indicates that the sample difference is 160 samples for the previous frame, the electronic device 104 may limit the sample difference to 140 samples.

The electronic device 104 may also limit the previous lag value. To ensure that the transient decoder 468 receives a previous lag value that is within range, the electronic device 104 may limit the previous lag value to a minimum lag threshold. For example, the minimum lag threshold may be 20 samples, or another value supported by the transient decoder 468. Therefore, if a bad packet 114 or erased frame indicates that the previous lag value is less than 20, the electronic device 104 may limit (e.g., set) the previous lag value to 20 samples.

It should be noted that the y or vertical axis in FIG. 7 plots the amplitude (e.g., signal amplitudes) of the waveform. The x or horizontal axis in FIG. 7 illustrates samples, which may be taken over a period of time (20 milliseconds, for example). Depending on the configuration, the signal itself may be a voltage, current or a pressure variation, etc.

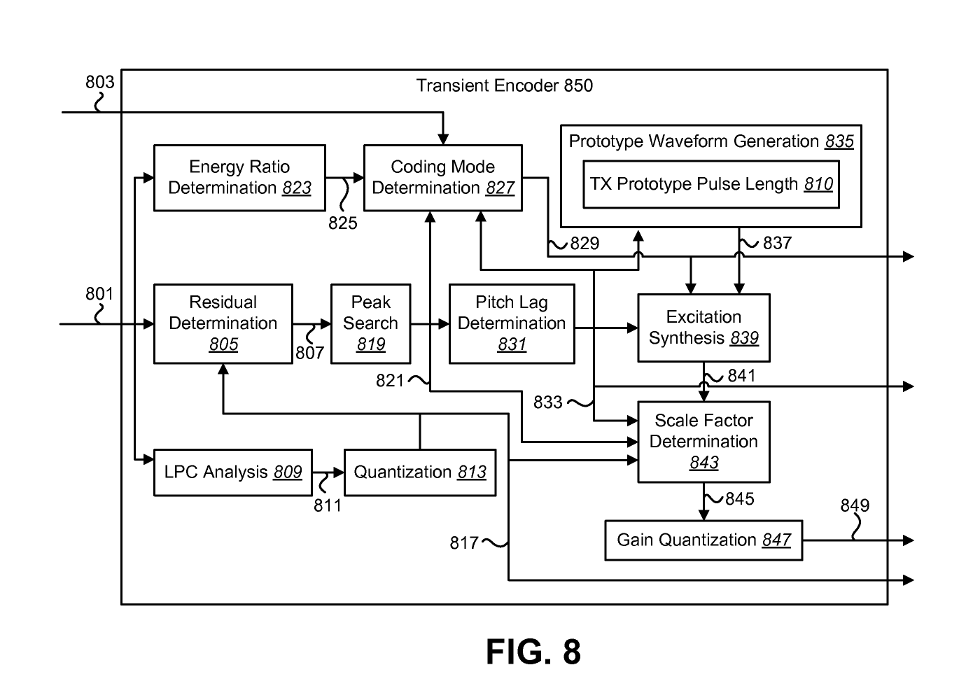

FIG. 8 is a block diagram illustrating one configuration of a transient encoder 850 in which systems and methods for mitigating speech signal quality degradation may be implemented. One example of the transient encoder 850 is a Linear Predictive Coding (LPC) encoder. The transient encoder 850 may be used by an electronic device 104 to encode a speech (or audio) signal 106. The transient encoder 850 may be one of the encoders included in the encoder 108 as illustrated in FIG. 1 and/or may be the transient encoder 350 as illustrated in FIG. 3.

An electronic device 104 may obtain a speech signal 106. The electronic device 104 may segment the speech signal 106 into one or more frames 801. When the speech signal 106 is segmented into frames 801, the frames 801 may be classified according to the signal that they contain. For example, the electronic device 104 may determine whether the frame 801 is a voiced frame, an unvoiced frame, a silent frame or a transient frame.

A transient frame 801, for example, may be situated on the boundary between one speech class and another speech class. For instance, a speech signal 106 may transition from an unvoiced sound (e.g., f, s, sh, th, etc.) to a voiced sound (e.g., a, e, i, o, u, etc.). Some transient types include up-transients (when transitioning from an unvoiced to a voiced part of a speech signal 106, for example), plosives, voiced transients (e.g., Linear Predictive Coding (LPC) changes and pitch lag variations) and down-transients (when transitioning from a voiced to an unvoiced or silent part of a speech signal 106 such as word endings, for example). A frame 801 in-between the two speech classes may be a transient frame 801. Furthermore, transient frames 801 may be further classified as voiced transient frames 801 or other transient frames 801. The systems and methods disclosed herein may be beneficially applied to transient frames 801.

The electronic device 104 may select the transient encoder 850 to code the frame 801. For example, if a frame type 803 indicates that the frame 801 is transient, then the electronic device 104 may provide the transient frame 801 to the transient encoder 850. However, if the frame type 803 indicates that the frame 801 is another kind of frame 801 that is not transient (e.g., voiced, unvoiced, silent, etc.), then the electronic device 104 may provide the other frame 801 to another encoder 108. The electronic device 104 may provide the frame type 803 to a coding mode determination block/module 827.

The transient encoder 850 may use a linear predictive coding (LPC) analysis block/module 809 to perform a linear prediction analysis (e.g., LPC analysis) on a transient frame 801. It should be noted that the LPC analysis block/module 809 may additionally or alternatively use one or more samples from a previous frame 801. For example, in the case that the previous frame 801 is a transient frame 801, the LPC analysis block/module 809 may use one or more samples from the previous transient frame 801. Furthermore, if the previous frame 801 is another kind of frame (e.g., voiced, unvoiced, silent, etc.) 801, the LPC analysis block/module 809 may use one or more samples from the previous other frame 801.

The LPC analysis block/module 809 may produce one or more LPC coefficients 811. Examples of LPC coefficients 811 include line spectral frequencies (LSFs) and line spectral pairs (LSPs). The LPC coefficients 811 may be provided to a quantization block/module 813, which may produce one or more quantized LPC coefficients 817. The quantized LPC coefficients 817 and one or more samples from one or more transient frames 801 may be provided to a residual determination block/module 805, which may be used to determine a residual signal 807. For example, a residual signal 807 may include a transient frame 801 of the speech signal 106 that has had the formants or the effects of the formants (e.g., coefficients) removed from the speech signal 106. The residual signal 807 may be provided to a peak search block/module 819.

The peak search block/module 819 may search for peaks in the residual signal 807. In other words, the transient encoder 850 may search for peaks (e.g., regions of high energy) in the residual signal 807. These peaks may be identified to obtain a list or set of peaks 821 that includes one or more peak locations. Peak locations in the list or set of peaks 821 may be specified in terms of sample number and/or time, for example.

The set of peaks 821 may be provided to the coding mode determination block/module 827, a pitch lag determination block/module 831 and/or a scale factor determination block/module 843. The pitch lag determination block/module 831 may use the set of peaks 821 to determine a pitch lag 833 (e.g., lag value). A “pitch lag” may be a “distance” between two successive pitch spikes in a frame 801. A pitch lag 833 may be specified in a number of samples and/or an amount of time, for example. In some configurations, the pitch lag determination block/module 831 may use the set of peaks 821 or a set of pitch lag candidates (which may be the distances between the peaks 821) to determine the pitch lag 833. For example, the pitch lag determination block/module 831 may use an averaging or smoothing algorithm to determine the pitch lag 833 from a set of candidates. Other approaches may be used. The pitch lag 833 determined by the pitch lag determination block/module 831 may be provided to the coding mode determination block/module 827, an excitation synthesis block/module 839 and/or a scale factor determination block/module 843.

The coding mode determination block/module 827 may determine a coding mode (indicator or parameter) 829 for a transient frame 801. In one configuration, the coding mode determination block/module 827 may determine whether to use a first coding mode for a transient frame 801 or a second coding mode for a transient frame 801. For instance, the coding mode determination block/module 827 may determine whether the transient frame 801 is a voiced transient frame or other transient frame. The coding mode determination block/module 827 may use one or more kinds of information to make this determination. For example, the coding mode determination block/module 827 may use a set of peaks 821, a pitch lag 833, an energy ratio 825, a frame type 803 and/or other information to make this determination.

The energy ratio 825 may be determined by an energy ratio determination block/module 823 based on an energy ratio between a previous frame 801 and a current transient frame 801. The previous frame 801 may be a transient frame 801 or another kind of frame 801 (e.g., silence, voiced, unvoiced, etc.). Thus, the transient encoder block/module 850 may identify regions of importance in the transient frame 801. It should be noted that these regions may be identified since a transient frame 801 may not be very uniform and/or stationary. In general, the transient encoder 850 may identify a set of peaks 821 in the residual signal 807 and use the peaks 821 to determine a coding mode 829. The selected coding mode 829 may then be used to “encode” or “synthesize” the speech signal in the transient frame 801.

The coding mode determination block/module 827 may generate a coding mode 829 that indicates a selected coding mode 829 for transient frames 801. For example, the coding mode 829 may indicate a first coding mode if the current transient frame 801 is a “voiced transient” frame 801 or may indicate a second coding mode if the current transient frame 801 is an “other transient” frame 801. The coding mode 829 may be sent (e.g., provided) to the excitation synthesis block/module 839, to storage, to a (local) decoder 120 and/or to a remote decoder 120.

The excitation synthesis block/module 839 may generate or synthesize an excitation 841 based on the coding mode 829, the pitch lag 833 and a prototype waveform 837 provided by a prototype waveform generation block/module 835. The prototype waveform generation block/module 835 may generate the prototype waveform 837 based on a spectral shape and/or a pitch lag 833. In one configuration, the prototype waveform generation block/module 835 may include a TX prototype pulse length block/module 810. The TX prototype pulse length block/module 810 may limit the prototype pulse length generated by the prototype waveform generation block/module 835 to the maximum length supported by the transient encoder 850. This may be accomplished as described above in connection with FIG. 3. In one implementation, the prototype pulse length may be limited to 160 samples.

The excitation 841, the set of peaks 821, the pitch lag 833 and/or the quantized LPC coefficients 817 may be provided to a scale factor determination block/module 843, which may produce a set of gains (e.g., scaling factors) 845 based on the excitation 841, the set of peaks 821, the pitch lag 833 and/or the quantized LPC coefficients 817. The set of gains 845 may be provided to a gain quantization block/module 847 that quantizes the set of gains 845 to produce a set of quantized gains 849.

The pitch lag 833, the quantized LPC coefficients 817, the quantized gains 849, the frame type 803 and/or the coding mode 829 may be transmitted to another device, stored and/or decoded. For example, the pitch lag 833, the quantized LPC coefficients 817, the quantized gains 849, the frame type 803 and/or the coding mode 829 may be formatted into one or more packets 114. The one or more packets 114 may be transmitted using a wireless and/or wired connection or link. In some configurations, the one or more packets 114 may be relayed by satellite, base station, routers, switches and/or other devices or mediums.

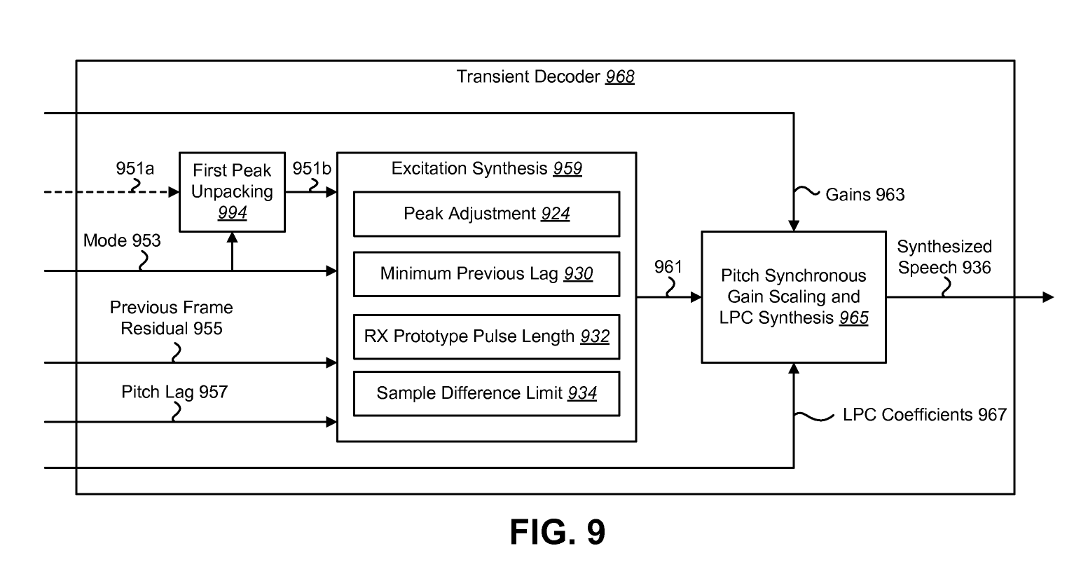

FIG. 9 is a block diagram illustrating one configuration of a transient decoder 968 in which systems and methods for mitigating speech signal quality degradation may be implemented. The transient decoder 968 may include an optional first peak unpacking block/module 994, an excitation synthesis block/module 959 and/or a pitch synchronous gain scaling and LPC synthesis block/module 965. The transient decoder 968 may be one of the decoders included with the decoder 120 as illustrated in FIG. 1 and/or may be the transient decoder 468 included as illustrated in FIG. 4.

The transient decoder 968 may obtain one or more of gains 963, a first peak location 951a (parameter), a mode 953, a previous frame residual 955, a pitch lag 957 (e.g., lag value) and LPC coefficients 967. For example, a transient encoder 350 may provide the gains 963, the first peak location 951a, the mode 953, the pitch lag 957 and/or LPC coefficients 967. It should be noted that the previous frame residual may be a previous frame's decoded residual that the decoder uses to reconstruct the synthesized speech signal for a previous frame. In one configuration, this information 951a, 953, 957, 963, 967 may originate from an encoder 108 that is on the same electronic device 104 as the decoder 968. For instance, the transient decoder 968 may receive the information 951a, 953, 957, 963, 967 directly from an encoder 108 or may retrieve it from memory. In another configuration, the information 951a, 953, 957, 963, 967 may originate from an encoder 108 that is on a different electronic device 104 from the decoder 968. For instance, the transient decoder 968 may obtain the information 951a, 953, 957, 963, 967 from a receiver 116 that has received it from another electronic device 104. It should be noted that the first peak location 951a may not always be provided by an encoder 108, such as when a first coding mode (e.g., voiced transient coding mode) is used.

In some configurations, the gains 963, the first peak location 951a, the mode 953, the pitch lag 957 and/or LPC coefficients 967 may be received as parameters. More specifically, the transient decoder 968 may receive a gains parameter 963, a first peak location parameter 951a, a mode parameter 953, a pitch lag parameter 957 and/or an LPC coefficients parameter 967. For instance, each type of this information 951a, 953, 957, 963, 967 may be represented using a number of bits. In one configuration, these bits may be received in a packet 114. The bits may be unpacked, interpreted, de-formatted and/or decoded by an electronic device 104 and/or the transient decoder 968 such that the transient decoder 968 may use the information 951a, 953, 957, 963, 967. In one configuration, bits may be allocated for the information 951a, 953, 957, 963, 967 as set forth in Table (1).

TABLE 1

| | Number of Bits for | Number of Bits for |
|---|---|---|
| Parameter | Voiced Transients | Other Transients |
| LPC Coefficients 967 | 18 | 18 |
| (e.g., LSPs or LSFs) | | |
| Transient Coding | 1 | 1 |
| Mode 953 | | |
| First Peak Location | — | 3 |
| (in frame) 951a | | |
| Pitch Lag 957 | 7 | 7 |
| Frame Type | 2 | 2 |
| Gain 963 | 8 | 8 |
| Frame Error | 2 | 1 |
| Protection | | |
| Total | 38 | 40 |

It should be noted that the frame type parameter illustrated in Table (1) may be used to select a decoder (e.g., NELP decoder 466, QPPP decoder 470, silence decoder 464, transient decoder 468, etc.) and frame error protection may be used to protect against (e.g., detect) frame errors.

The mode 953 may indicate whether a first coding mode (e.g., coding mode A or a voiced transient coding mode) or a second coding mode (e.g., coding mode B or an “other transient” coding mode) was used to encode a speech or audio signal. The mode 953 may be provided to the first peak unpacking block/module 994 and/or to the excitation synthesis block/module 959.

If the mode 953 indicates a second coding mode (e.g., other transient coding mode), then the first peak unpacking block/module 994 may retrieve or unpack a first peak location 951b. For example, the first peak location 951a received by the transient decoder 968 may be a first peak location parameter 951a that represents the first peak location using a number of bits (e.g., three bits). Additionally or alternatively, the first peak location 951a may be included in a packet 114 with other information (e.g., header information, other payload information, etc.). The first peak unpacking block/module 994 may unpack the first peak location parameter 951a and/or interpret (e.g., decode, de-format, etc.) the peak location parameter 951a to obtain a first peak location 951b. In some configurations, however, the first peak location 951a may be provided to the transient decoder 968 in a format such that unpacking is not needed. In that configuration, the transient decoder 968 may not include a first peak unpacking block/module 994 and the first peak location 951 may be provided directly to the excitation synthesis block/module 959.

In cases where the mode 953 indicates a first coding mode (e.g., voiced transient coding mode), the first peak location (parameter) 951a may not be received and/or the first peak unpacking block/module 994 may not need to perform any operation. In such a case, a first peak location 951 may not be provided to the excitation synthesis block/module 959.

The excitation synthesis block/module 959 may synthesize an excitation 961 based on a pitch lag 957, a previous frame residual 955, a mode 953 and/or a first peak location 951. The first peak location 951 may only be used to synthesize the excitation 961 if the second coding mode (e.g., other transient coding mode) is used, for example.

The excitation synthesis block/module 959 may include a peak adjustment block/module 924, a minimum previous lag block/module 930, an RX prototype pulse length block/module 932 and a sample difference limit block/module 934. The peak adjustment block/module 924 may regulate an adjustment to the number of synthesized peaks as described above in connection with FIG. 4. The minimum previous lag block/module 930 may limit the pitch lag 957 to a minimum lag threshold as described above in connection with FIG. 4. The sample difference limit block/module 934 may limit the sample difference between two pitch positions of a previous frame to a maximum difference threshold as described above in connection with FIG. 4. The RX prototype pulse length block/module 932 may limit the prototype pulse length to a maximum length as described above in connection with FIG. 4.

The excitation 961 may be provided to the pitch synchronous gain scaling and LPC synthesis block/module 965. The pitch synchronous gain scaling and LPC synthesis block/module 965 may use the excitation 961, the gains 963 and the LPC coefficients 967 to produce a synthesized or decoded speech signal 936. The synthesized speech signal 936 may be stored in memory, be output (after digital to analog conversion) using a speaker and/or be transmitted to another electronic device.

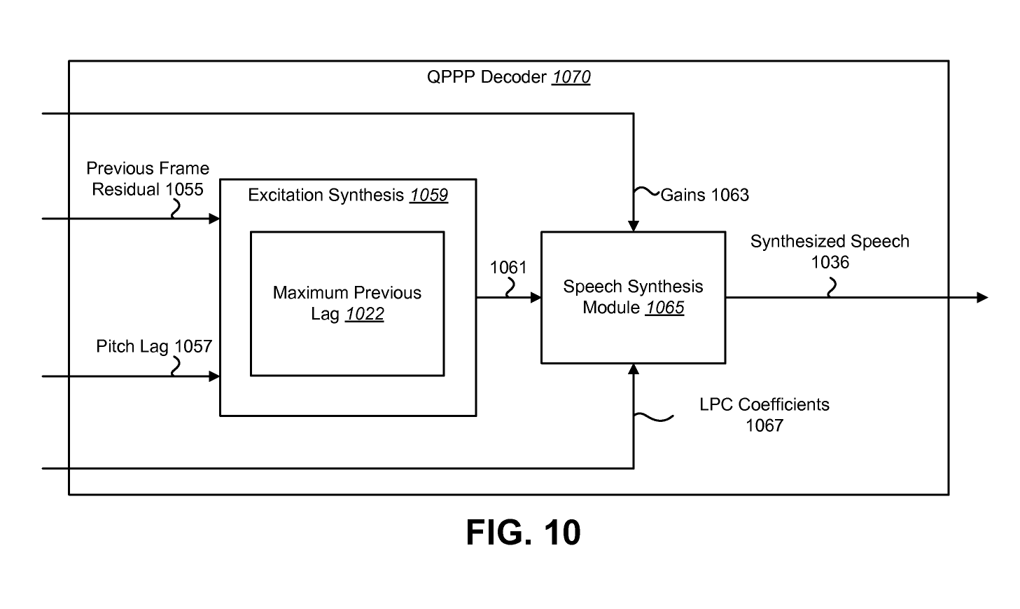

FIG. 10 is a block diagram illustrating one configuration of a QPPP decoder 1070 in which systems and methods for mitigating speech signal quality degradation may be implemented. The QPPP decoder 1070 may include an excitation synthesis block/module 1059 and/or a speech synthesis block/module 1065. In one configuration, the QPPP decoder 1070 may be located on the same electronic device 104 as an encoder 108. In another configuration, the QPPP decoder 1070 may be located on an electronic device 104 that is different from an electronic device 104 where an encoder 108 is located. The QPPP decoder 1070 may be one of the decoders included with the decoder 120 as illustrated in FIG. 1 and/or may be the QPPP decoder 470 included as illustrated in FIG. 4.

The QPPP decoder 1070 may obtain or receive one or more parameters that may be used to generate a synthesized speech signal 1036. For example, the QPPP decoder 1070 may obtain one or more gains 1063, a previous frame residual signal 1055, a pitch lag 1057 (e.g., lag value) and/or one or more LPC coefficients 1067.

The previous frame residual 1055 may be provided to the excitation synthesis block/module 1059. The previous frame residual 1055 may be derived from a previously decoded frame. A pitch lag 1057 may also be provided to the excitation synthesis block/module 1059. The excitation synthesis block/module 1059 may synthesize an excitation 1061. For example, the excitation synthesis block/module 1059 may synthesize a transient excitation 1061 based on the previous frame residual 1055 and/or the pitch lag 1057. The excitation synthesis block/module 1059 may include a maximum previous lag block/module 1022. The maximum previous lag block/module 1022 may limit the previous lag value that is used in erasure processing as described above in connection with FIG. 4.

The synthesized excitation 1061, the one or more (quantized) gains 1063 and/or the one or more LPC coefficients 1067 may be provided to the speech synthesis block/module 1065. The speech synthesis block/module 1065 may generate a synthesized speech signal 1036 based on the synthesized excitation 1061, the one or more (quantized) gains 1063 and/or the one or more LPC coefficients 1067. The synthesized speech signal 1036 may be output from the QPPP decoder 1070. For example, the synthesized speech signal 1036 may be stored in memory or output (e.g., converted to an acoustic signal) using a speaker.

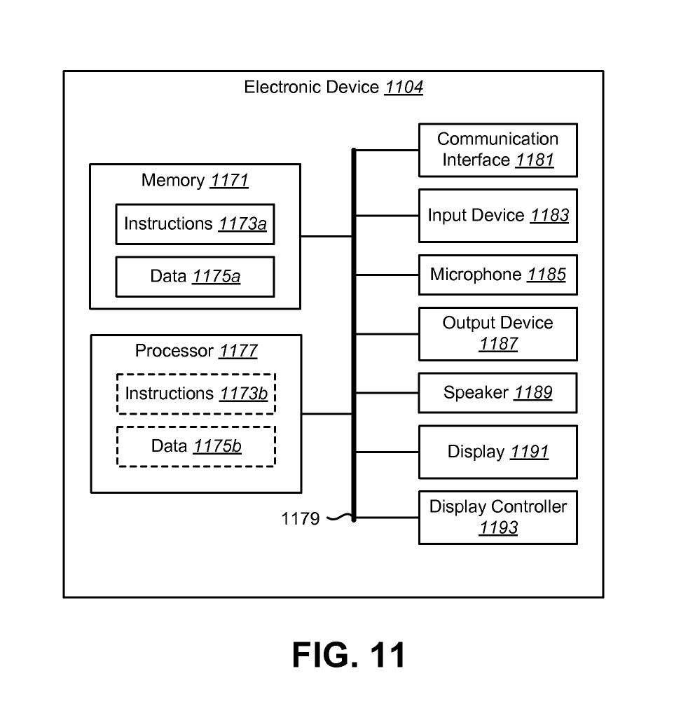

FIG. 11 illustrates various components that may be utilized in an electronic device 1104. The illustrated components may be located within the same physical structure or in separate housings or structures. The electronic devices 104 discussed previously may be configured similarly to the electronic device 1104. The electronic device 1104 includes a processor 1177. The processor 1177 may be a general purpose single- or multi-chip microprocessor (e.g., an Advanced RISC (Reduced Instruction Set Computer) Machine (ARM) processor), a special purpose microprocessor (e.g., a digital signal processor (DSP)), a microcontroller, a programmable gate array, etc. The processor 1177 may be referred to as a central processing unit (CPU). Although just a single processor 1177 is shown in the electronic device 1104 of FIG. 11, in an alternative configuration, a combination of processors (e.g., an ARM and DSP) could be used.

The electronic device 1104 also includes memory 1171 in electronic communication with the processor 1177. That is, the processor 1177 can read information from and/or write information to the memory 1171. The memory 1171 may be any electronic component capable of storing electronic information. The memory 1171 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1175a and instructions 1173a may be stored in the memory 1171. The instructions 1173a may include one or more programs, routines, sub-routines, functions, procedures, etc. The instructions 1173a may include a single computer-readable statement or many computer-readable statements. The instructions 1173a may be executable by the processor 1177 to implement the methods 200, 500, 600 described above. Executing the instructions 1173a may involve the use of the data 1175a that is stored in the memory 1171. FIG. 11 shows some instructions 1173b and data 1175b being loaded into the processor 1177 (which may come from instructions 1173a and data 1175a).

The electronic device 1104 may also include one or more communication interfaces 1181 for communicating with other electronic devices. The communication interfaces 1181 may be based on wired communication technology, wireless communication technology, or both. Examples of different types of communication interfaces 1181 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The electronic device 1104 may also include one or more input devices 1183 and one or more output devices 1187. Examples of different kinds of input devices 1183 include a keyboard, mouse, microphone, remote control device, button, joystick, trackball, touchpad, lightpen, etc. For instance, the electronic device 1104 may include one or more microphones 1185 for capturing acoustic signals. In one configuration, a microphone 1185 may be a transducer that converts acoustic signals (e.g., voice, speech) into electrical or electronic signals. Examples of different kinds of output devices 1187 include a speaker, printer, etc. For instance, the electronic device 1104 may include one or more speakers 1189. In one configuration, a speaker 1189 may be a transducer that converts electrical or electronic signals into acoustic signals. One specific type of output device which may be typically included in an electronic device 1104 is a display device 1191. Display devices 1191 used with configurations disclosed herein may utilize any suitable image projection technology, such as a cathode ray tube (CRT), liquid crystal display (LCD), light-emitting diode (LED), gas plasma, electroluminescence, or the like. A display controller 1193 may also be provided, for converting data stored in the memory 1171 into text, graphics, and/or moving images (as appropriate) shown on the display device 1191.

The various components of the electronic device 1104 may be coupled together by one or more buses, which may include a power bus, a control signal bus, a status signal bus, a data bus, etc. For simplicity, the various buses are illustrated in FIG. 11 as a bus system 1179. It should be noted that FIG. 11 illustrates only one possible configuration of an electronic device 1104. Various other architectures and components may be utilized.

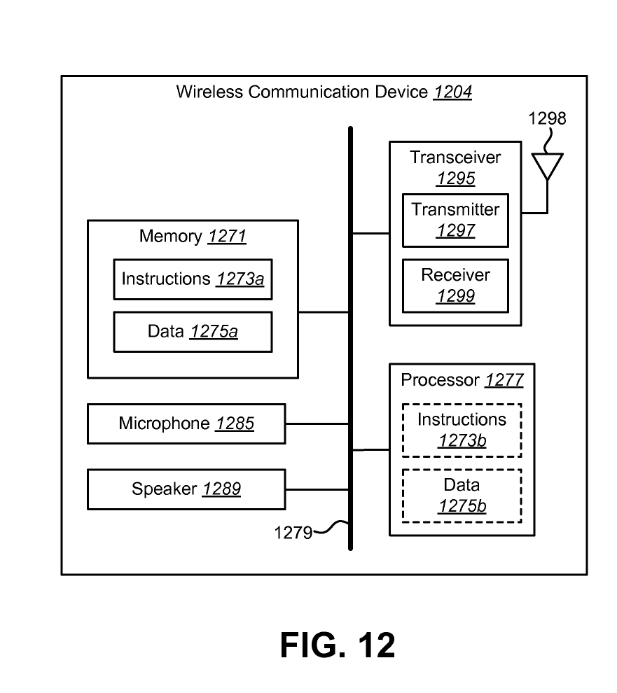

FIG. 12 illustrates certain components that may be included within a wireless communication device 1204. The electronic devices 104 described above may be configured similarly to the wireless communication device 1204 that is shown in FIG. 12.

The wireless communication device 1204 includes a processor 1277. The processor 1277 may be a general purpose single- or multi-chip microprocessor (e.g., an ARM), a special purpose microprocessor (e.g., a digital signal processor (DSP)), a microcontroller, a programmable gate array, etc. The processor 1277 may be referred to as a central processing unit (CPU). Although just a single processor 1277 is shown in the wireless communication device 1204 of FIG. 12, in an alternative configuration, a combination of processors (e.g., an ARM and DSP) could be used.

The wireless communication device 1204 also includes memory 1271 in electronic communication with the processor 1277 (i.e., the processor 1277 can read information from and/or write information to the memory 1271). The memory 1271 may be any electronic component capable of storing electronic information. The memory 1271 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1275a and instructions 1273a may be stored in the memory 1271. The instructions 1273a may include one or more programs, routines, sub-routines, functions, procedures, code, etc. The instructions 1273a may include a single computer-readable statement or many computer-readable statements. The instructions 1273 may be executable by the processor 1277 to implement the methods 200, 500, 600 described above. Executing the instructions 1273a may involve the use of the data 1275a that is stored in the memory 1271. FIG. 12 shows some instructions 1273b and data 1275b being loaded into the processor 1277 (which may come from instructions 1273a and data 1275a).

The wireless communication device 1204 may also include a transmitter 1297 and a receiver 1299 to allow transmission and reception of signals between the wireless communication device 1204 and a remote location (e.g., another electronic device, communication device, etc.). The transmitter 1297 and receiver 1299 may be collectively referred to as a transceiver 1295. An antenna 1298 may be electrically coupled to the transceiver 1295. The wireless communication device 1204 may also include (not shown) multiple transmitters, multiple receivers, multiple transceivers and/or multiple antenna.

In some configurations, the wireless communication device 1204 may include one or more microphones 1285 for capturing acoustic signals. In one configuration, a microphone 1285 may be a transducer that converts acoustic signals (e.g., voice, speech) into electrical or electronic signals. Additionally or alternatively, the wireless communication device 1204 may include one or more speakers 1289. In one configuration, a speaker 1289 may be a transducer that converts electrical or electronic signals into acoustic signals.

The various components of the wireless communication device 1204 may be coupled together by one or more buses, which may include a power bus, a control signal bus, a status signal bus, a data bus, etc. For simplicity, the various buses are illustrated in FIG. 12 as a bus system 1279.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 2, FIG. 5 and FIG. 6, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for decoding a speech signal, comprising:
obtaining a packet;
obtaining a previous lag value;
limiting the previous lag value if the previous lag value is greater than a maximum lag threshold; and
disallowing an adjustment to a number of synthesized peaks if a combination of the number of synthesized peaks and an estimated number of peaks is not valid.

2. The method of claim 1, wherein the packet is a packet with errors or the packet comprises an erased frame.

3. The method of claim 1, further comprising disallowing the adjustment to the number of synthesized peaks if an adjusted number of synthesized peaks is not within a maximum peak number threshold.

4. The method of claim 1, wherein the estimated number of peaks is based on a current frame size and a current lag value.

5. The method of claim 1, further comprising:
obtaining a current lag value; and
declaring the packet as a bad packet if the current lag value exceeds a transient mode lag threshold.

6. The method of claim 1, further comprising:
obtaining reserved bits from the packet; and
declaring the packet as a bad packet if at least one reserved bit is a non-zero bit.

7. The method of claim 1, further comprising limiting the previous lag value if the previous lag value is less than a minimum lag threshold.

8. The method of claim 1, further comprising limiting a prototype pulse length to a maximum length.

9. The method of claim 1, further comprising limiting a difference in samples between two pulses in an excitation of a previous frame to a maximum difference threshold.

10. The method of claim 1, wherein the method is performed by a service option 77 enhanced variable rate codec vocoder.

11. An electronic device for decoding a speech signal, comprising:
receiver circuitry configured to obtain a packet; and
decoder circuitry configured to obtain a previous lag value, to limit the previous lag value if the previous lag value is greater than a maximum lag threshold, and to disallow an adjustment to a number of synthesized peaks if a combination of the number of synthesized peaks and an estimated number of peaks is not valid.

12. The electronic device of claim 11, wherein the decoder circuitry is further configured to disallow an adjustment to the number of synthesized peaks if an adjusted number of synthesized peaks is not within a maximum peak number threshold.

13. The electronic device of claim 11, wherein the decoder circuitry is further configured to limit the previous lag value if the previous lag value is less than a minimum lag threshold.

14. The electronic device of claim 11, wherein the decoder circuitry is further configured to limit a prototype pulse length to a maximum length.

15. The electronic device of claim 11, wherein the decoder circuitry is further configured to limit a difference in samples between two pulses in an excitation of a previous frame to a maximum difference threshold.

16. A computer-program product for decoding a speech signal, comprising a non-transitory tangible computer-readable medium having instructions thereon, the instructions comprising:
code for causing an electronic device to obtain a packet;
code for causing the electronic device to obtain a previous lag value;
code for causing the electronic device to limit the previous lag value if the previous lag value is greater than a maximum lag threshold; and
code for causing the electronic device to disallow an adjustment to a number of synthesized peaks if a combination of the number of synthesized peaks and an estimated number of peaks is not valid.

17. The computer-program product of claim 16, further comprising code for causing the electronic device to disallow an adjustment to the number of synthesized peaks if an adjusted number of synthesized peaks is not within a maximum peak number threshold.

18. The computer-program product of claim 16, further comprising code for causing the electronic device to limit the previous lag value if the previous lag value is less than a minimum lag threshold.

19. The computer-program product of claim 16, further comprising code for causing the electronic device to limit a prototype pulse length to a maximum length.

20. The computer-program product of claim 16, further comprising code for causing the electronic device to limit a difference in samples between two pulses in an excitation of a previous frame to a maximum difference threshold.
